(19) United States
(12) Patent Application Publication
(10) Pub. No.: US 2021/0048521 A1
(43) Pub. Date: Feb. 18, 2021

(54) SYSTEMS, METHODS, APPARATUSES, AND DEVICES FOR FACILITATING PERFORMING OF MOTION ANALYSIS IN A FIELD OF INTEREST

(71) Applicant: RELIANCE CORE CONSULTING LLC, Alexandria, VA (US)

(72) Inventor: Jean-Pierre Leduc, Clarksburg, MD (US)

(21) Appl. No.: 16/992,619

(22) Filed: Aug. 13, 2020

Related U.S. Application Data
(60) Provisional application No. 62/886,275, filed on Aug. 13, 2019.

(51) Int. Cl. G01S 13/524; G06T 7/20; G01S 13/89; G01S 13/75

(52) U.S. Cl. CPC G01S 13/5242; G01S 13/75; G01S 13/89; G06T 7/20

(57) ABSTRACT

Disclosed herein is a system for facilitating performing of motion analysis in a field of interest, in accordance with some embodiments. Accordingly, the system may include a passive sensor, an active sensor, a processing device, a gateway, and a remote monitoring center. Further, the passive sensor and the active sensor is disposed in the field of interest. Further, the passive sensor generates passive sensor data. Further, the active sensor produces second waves, receives transformed waves, and generates active sensor data. Further, the gateway is configured for transmitting the passive sensor data and the active sensor data to the remote monitoring center. Further, the remote monitoring center is configured for performing the motion analysis. Further, the remote monitoring center may include a remote processing device configured for combining the passive sensor data and the active sensor data and generating motion information based on the combining.

The current application claims a priority to the U.S. Provisional Patent application Ser. No. 62/886,275 filed on Aug. 13, 2019.

### FIELD OF INTEREST

### Field of the Invention

Generally, the present disclosure relates to a field of data processing. More specifically, the present disclosure relates to systems, methods, apparatuses, and devices for facilitating performing of motion analysis in a field of interest.

### Background of the Invention

Motion is one of the most crucial pieces of information. Early, before achieving any high resolution, nature developed a vision for motion detection and control for the critical purpose of survival, defense, and hunting. In this context, the goal is to develop motion-intelligent systems that perform motion analysis, supervision, and control on the delimited field out of the physical world.

Existing techniques for performing of motion analysis in a field of interest are deficient with regard to several aspects. For instance, current technologies do not use multiple sensors for generating multiple information for motion analysis. Furthermore, current technologies do not combine multiple information for motion analysis.

Therefore, there is a need for improved systems, methods, apparatuses, and devices for facilitating performing of motion analysis in a field of interest that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a system for facilitating performing of motion analysis in a field of interest, in accordance with some embodiments. Accordingly, the system may include at least one passive sensor, at least one active sensor, at least one gateway, and a remote monitoring center. Further, the at least one passive sensor may be disposed in the field of interest. Further, the field of interest may include at least one object associated with at least one motion. Further, the at least one passive sensor may be configured for generating passive sensor data based on receiving of first waves associated with the field of interest. Further, the at least one active sensor may be disposed in the field of interest. Further, the at least one active sensor may be configured for producing second waves. Further, the second waves may be configured for reflecting of the at least one object based on the producing. Further, the at least one active sensor may be configured for receiving transformed waves based on the reflecting. Further, the at least one active sensor may be configured for generating active sensor data based on the receiving of the transformed waves. Further, the at least one gateway may be disposable proximal to the field of interest. Further, the at least one gateway may be configured as a two-way interface capable of communicating with a remote monitoring center, the at least one passive sensor, and the at least one active sensor. Further, the at least one gateway may be configured for transmitting the passive sensor data and the active sensor data to the remote monitoring center. Further, the remote monitoring center may be configured for performing the motion analysis. Further, the remote monitoring center may include a remote processing device. Further, the remote processing device may be configured for combining the passive sensor data and the active sensor data. Further, the remote processing device may be configured for generating motion information based on the combining.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is an illustration of an online platform consistent with various embodiments of the present disclosure.

FIG. 2 is a block diagram of a system for facilitating performing of motion analysis in a field of interest, in accordance with some embodiments.

FIG. 3 is a block diagram of a system for facilitating performing of motion analysis in a field of interest, in accordance with some embodiments.

FIG. 4 is a schematic of a motion sensor system for facilitating motion analysis, in accordance with some embodiments.

FIG. 5 is a schematic of a motion-intelligent system for facilitating motion analysis, in accordance with some embodiments.

FIG. 6 is a flow diagram of a method for facilitating sensor fusion and parameter estimation, in accordance with some embodiments.

FIG. 7 is a graphical representation of acuity versus range for a plurality of sensors in an environmental condition, in accordance with some embodiments.

FIG. 8 is a graphical representation of acuity versus range for a plurality of sensors in an environmental condition, in accordance with some embodiments.

FIG. 9 is a graphical representation of acuity versus range for a plurality of sensors in an environmental condition, in accordance with some embodiments.

FIG. 10 is a graphical representation of acuity versus range for a plurality of sensors in an environmental condition, in accordance with some embodiments.

FIG. 11 is schematic of a motion sensor network and a camera in an arrangement, in accordance with some embodiments.

FIG. 12 is an illustration of projections of a field of interest, in accordance with some embodiments.

FIG. 13 is a schematic of a system for facilitating Motion sensor Functions, in accordance with some embodiments.

FIG. 14 is a schematic of a plurality of sensors disposed on a field of interest, in accordance with some embodiments.

FIG. 15 is a schematic of a system for facilitating motion analysis, in accordance with some embodiments.

FIG. 16 is a graphical representation of neuro-dynamic programming for facilitating motion analysis, in accordance with some embodiments.

FIG. 17 is a schematic describing an artificial intelligence software for facilitating motion analysis, in accordance with some embodiments.

FIG. 18 is schematic of an active motion sensor network, in accordance with some embodiments.

FIG. 19 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

### Overview

The present disclosure describes systems, methods, apparatuses, and devices for facilitating performing of motion analysis in a field of interest. Further, the systems may include a generic algorithm.

Generic Algorithm Description:

The field of interest defines a three-dimensional space and time space, referred by the acronym “3D+T” to be monitored. Examples of such fields are commercial and business premises, residential, public and administrative buildings, parking garages, transportation stations and undergrounds, airports, private properties/residences, city streets, and battlefields. The fields may be categorized into three main varieties namely motion-intelligent buildings.

Motion Analysis Means:
1. Motion detection of moving patterns.
2. Motion-oriented classification & selection of the detected moving patterns.
3. Estimation of the kinematic parameters. Kinematic parameters are velocity, position, scale, and orientation.
4. Prediction of the kinematic parameters.
5. Tracking to build trajectories of moving patterns of interest.
6. Detection, indication, and prediction of abnormalities, incidents, and accidents.
7. Focusing on patterns of interest.

The deep learning neural network along with the expert system is able to analyze the captured signals according to different motion parameters of interest. These motion parameters are defined as follows from different spatiotemporal transformations. The algorithm incorporates the following transformation parameters:
1. Spatial and temporal translations, with respective parameters denoted by b∈R3 and τ∈R, provide the spatial and temporal location.
2. Spatial rotation, with the parameter, denoted y r∈SO (3), the matrix of rotation in three-dimensions, provides the orientation.
3. Spatial dilation, with non-zero positive parameter a∈R+, provides the scale.
4. Velocity transformation with parameter v∈R3.

Further, the motion analysis is performed with motion sensors which are passive devices built up with a small array of photodetectors controlled by a processing unit. Those sensor devices may be distributed inside the building with adequate density and regularity to capture all motion taking place. Additional motion sensors operating with active devices by sensing electromagnetic and/or acoustic waves may be added to the system. Those active sensors emit waves, microwave, infra-red or ultrasound, that scan their surroundings and measure some physical properties, usually intensity and delay (commonly referred to as Time-Of-Flight, TOF), on the reflected waves which have been transformed by the moving objects. In those devices, speed (defined as the amplitude of the velocity vector component pointing towards the sensor) may also be measured by Doppler shifts.

Further, motion sensors are randomly distributed over the entire physical field of interest. The motion sensors are nodes located at the bottom of the entire networking system. The entire system may be decomposed into three major components and described with the following bottom-up approach:
1. A set of different sensors captures motion, provides high-resolution information, makes precise measurements, tags moving patterns of interest, and converts the information into data to be transmitted.
2. A tree-structured telecommunication system relays the data from the sensors to a data sink or gateway connecting to other means of communication.
3. A remote monitoring center receives the entire data and performs motion-intelligent supervision and control.

The motion analysis may be performed from digital signals captured from numerous sensors distributed in the field. The sensors belong to one of the following categories:
1. Motion sensors are passive photodetectors randomly spreading the field. Their purpose is to analyze and track motion throughout the field of interest through three spectral bands, namely the visible spectrum for optical imaging, the near-infrared for chemical imaging, and the mid-infrared for thermal imaging.
2. Multiple video cameras are located on key locations or embarked on moving systems such as drones or robots. Their purpose is to provide high-resolution images and videos for final pattern recognition.
3. Active motion-measurement devices are based on ultrasonic, microwave, or laser. Their purpose is to be used as indoor back-ups or for outdoor surveillance.
4. Marking sensors are passive walk-through detectors standing on key spots as specialized sensors detecting radioactive, chemical, and biological sources, and moving metal pieces. Marking sensors also include active devices such as active badges. Their purpose is to mark or label some moving patterns as an item of special interest entering the field, and specifically, to trace their path in the field of interest.

The motion sensors and the network components involved in local telecommunications to routers may be manufactured using innovative nanotechnology and Tera-Hertz communications to implement a local Internet of Nano-Things.

At the remote monitoring center, raw data are reconciled, sensors fused, and re-ordered in time and space on an up-dated topographic representation of both the field and the sensor locations originally acquired during the initial training phase. The motion analysis is performed by a neural network functioning in an adaptive dual control process with two main modes depending on the predictability or the unpredictability of the environment. In the former condition, the dual control proceeds with a deep learning process, and in the latter condition, with an expert system. The two main modes may be outlined as follows.
1. The deep learning process relies on an intelligence learned through training and updating phase from a big data source. This process is fast and refers to the empirical way of learning in the field.
2. The expert system is based on the accurate model of the mechanics in the field and the wave capture in the sensors. The expert processing process is slow and refers to the rational way of learning.

In situations of interest, the dual control may also proceed to a third mode that locks the control on specific patterns of interest. Human supervision may also have the possibility to react and sent remote-controlled mobile systems with embarked video-camera like drones or robots on a key location of the field. Under those circumstances, the remote monitoring center may be able to communicate directly with the mobile systems bypassing the network.

To yield an effective structure description, a motion-intelligent system may be subdivided into three components. The sensor layer which is the lowest physical layer responsible for the detection and the measurement of kinematic parameters. It includes different types of sensors.
1. The telecommunication layer is in charge to transmit the collected information to a gateway or a data sink. This layer includes the upper physical layer of the detectors, the components responsible for carrier generation, modulation and frequency selection, the data link layer, and the network layer.
2. The application layer which includes the transport layer (the Internet, radio or satellite communications) and the application layer (the Cloud, workstations specialized in Artificial Intelligence especially deep learning neural networks).

Further, the present disclosure describes a motion-intelligent system that performs motion analysis, supervision, and control from the digital signal captured from a network of motion sensors scattered over a physical field of interest and from multiple video cameras where “3D+T” motion analysis aims at being performed. Motion analysis means not only motion detection, motion-based classification, and recognition of moving patterns but also estimation, prediction, and tracking of kinematic parameters to build trajectories. Recognition and classification of moving patterns include a selection through scale and orientation. Shape recognition involves size, volume, and shape. Orientation recognition involves the perception of the main alignment like a horizontal, vertical, degree of inclination. The kinematic parameters are defined as spatial and temporal positions and velocity or speed. The velocity is a vector with three components and the speed is defined as the magnitude of the velocity vector. The contribution of video cameras is to provide the system with high-resolution images at locations that are crucial for the recognition and classification of moving patterns. The contribution of the motion sensor network is to bring motion detection, estimation, and tracking capabilities.

Further, motion sensors randomly distributed over the entire physical field of interest. The entire system may be described following a bottom-up approach and decomposed into three major components. Those components are as follows.
1. A set of different sensors captures motion, measurement, and moving-image information converts them into data to be transmitted.
2. A tree-structured telecommunication system relays the data from the sensors to a data sink.
3. A motion-intelligent supervising system receives the data.

The motion sensors are nodes located at the bottom of the entire networking system. The following proceeds to a detailed bottom-up description of the system.

The Motion Sensor Nodes:

The sensor nodes implement all the functions of the physical layer of the system. Those functions are responsible for signal detection, analog-to-digital conversion, entropy coding of the useful information into data to be transmitted with potential error-correcting codes, and encryption. The node uses an appropriate carrier frequency and an efficient modulation technique.

The number of motion sensor nodes in the network is supposed to be very high. A network may count a few hundred thousand to millions of motion sensor nodes. Two important properties and factors driving the design of motion-intelligent sensor networks may be fault tolerance and scalability. Those characteristics may serve as a guideline to design a protocol of communications inside the network.

Fault tolerance supposes that some sensors may fail to work momentarily by a lack of power of permanently by enduring physical damage. The failure of sensor nodes may not affect the overall task of the sensor network. By definition, fault tolerance is the ability to maintain sensor network functionalities without any interruption due to sensor node failures. The survival probability of a node, meaning the probability not to have a failure, within a time interval (0, t) is given in the whole generality by a Poisson process, Pₖ=e^{-λ}^{ₖ}^{t}; where λₖ is the failure arrival rate for a sensor node k and t is the time period. Failure may also occur by a cluster when a router located at a network node is failing or by any other means of subfield destruction.

The scalability is relating to the fact that the density of the sensor is scalable and may vary from region to region from a few sensor nodes in some areas to a few hundred of sensor nodes in some other areas. The density μ may be calculated following the formula,

μ(R)=(NπR²)/A;

where N is the number of scattered sensor nodes in area A, R is the radio transmission range.

The Telecommunication Network:

The telecommunication network has a hierarchical structure bottom up on the physical layer connecting sensors to sub-routers, a hierarchy of sub routers connects to routers, and the layer of routers connect to one gateway at the top of the tree structure. The structured telecommunication network implements the data link layer and the network layer of the system. The data link layer is responsible to establish the communication links for the data transfer following infrastructure of multi-hop wireless communications, to ensure reliable point-to-point or point-to-multipoint communications, to multiplex or aggregate the data collected from the sensors, to effectively share the telecommunication resources on the basis time, energy and frequency. The network layer is responsible to aggregate all the data potentially using additional intermediate nodes as relays and to eventually route the total information to a data sink (the gateway) located at the periphery outside the sensor field. The architecture of this telecommunication network may adapt to the specific structure of the field of interest and its division into subfields. The physical field of interest may be decomposed or divided into a hierarchy of subfields. Each subfield corresponds to a specific area or section of the field with its own properties, characteristics of interest. Each subfield is controlled by one main router. Since a subfield may still be divided into smaller areas, each router may control a set of sub-routers. Each router or sub-router has the ability to perform networking functions that are more complicated than those performed by the detector. Routers may be made of different technology, size, and radio communication capabilities. All routers eventually connect to one gateway which connects the entire system to a remote monitoring center through another network (Internet, satellite, radio). The Internet or other built-up external networks constitute the transport layer that connects the sink to the remote monitoring center.

The Intelligent Supervisions System:

The motion-intelligent supervising system located at a remote monitoring center manages the functionalities of the system. The remote monitoring center implements the application layer of the system. The incoming data provided by the gateways are processed in four major steps as follows:
1. The incoming data is reconciliated/fused and reconstructed in “3D+T” on the acquired topography of the field.
2. A deep learning artificial neural network supervised by an expert system implements the motion analysis of detection, recognition, and classification of moving patterns including abnormalities, incidents, and accidents.
3. Human supervision follows through to interpret all abnormal events and give more insight into the system. The supervisor may induce a top-down control forcing the system to update the knowledge of the environment, to activate additional sensors through routers, to involve video cameras moving with robots or drones, to focalize and perform a locked control for pattern recognition, measurement or capture.
4. A deep learning artificial neural network supervised by an expert system performs additional prediction on the kinematic parameters, data analytics, and trajectory construction.
5. All data are recorded, and the systems may produce, on-demand in real-time or delayed, all sorts of statistics performed on different terms varying from real-time, short terms hourly and daily to long terms monthly and yearly.

The motion-intelligent system is based on a deep learning neural network. The deep learning system needs to be initially trained and evaluated. It also requests to be updated when changes occur in the environment. An adaptive dual control enables that the Q-learning function take actions from different sources as follows:
1. The deep leaning estimation that is trained and updated to acquire the statistics of the environment, has learned and updated its capability of detection, recognition and classification, measurement, and tracking.
2. The expert system computations based on both the actual model of motion mechanics and the local topography of the system.
3. The precise measurements performed by active sensors in a locked mode.
4. The supervisor decision

At the remote monitoring center, the data originating from the gateway are analyzed for detection, recognition, and classification are presented in real-time to the supervisors. The supervisors have the possibility to select moving patterns of interest to be tracked and captured by the video cameras. The system classifies all detected motions, classified them by scale, shape, and any other criteria, performs pattern recognition from the cameras, estimate the trajectories from the data collected by the sensor system as far as it is feasible by real-time processing. All collected data are recorded to enable further off-line analyses and to perform statistics.

Artificial Intelligent System at the Application Layer:

The Artificial intelligence software of the application layer located at the remote monitoring center is composed of three (3) major components which are as follows.
1. A simulator.
2. A deep Q-learning system.
3. An expert system.

The deep Q-learning and expert systems both interact with each other according to a dual control as described earlier. The simulator is basically connected to one single (huge) screen. To operate the system, the human supervisor just needs to have one computer window to connect directly to a local computer, or through the Internet to a website where the cloud is accessible. The software gives access to a menu leading to different operating modes.

The Simulator:

The simulator implements a mapping representation of the three-dimensional field or environment to monitor taking into account the following characteristics:
1. The topography of the field (introduced from available maps and in-site measurements).
2. The light sources (position, intensity and range of radiance variation, and illumination pattern).
3. The sensors (all kinds in the field as included in the monitoring system, position, physical models of capturing and transforming irradiant energy into digital information).

In an initial stage, the simulator needs to be calibrated from the field in order to set up all the exact values of the set of parameters described in items 1 to 3 here-above: positions and characteristics of all sensors and light sources. The calibration proceeds further by training where patterns of different scale and orientation are passed through the field and their signatures recorded at all different positions and velocities. This training process may similarly train the deep Q-learning system and calibrate the expert system.

Once correctly calibrated, the simulator may perform in two following modes:
1. Simulation, meaning to generate/emulate virtual moving objects in the field, computing the data that may be received from the telecommunication network, infer their consequent representations in space and time on the field representation, display on the TV screen and feed the both the deep Q-learning and Expert System. Simulation representations need to be confronted with the expert system estimations to allow perfect matching and calibration between a simulator and an expert system. The simulator may then proceed to train the Q-learning system and the dual control first in terms of all relevant kinematic parameters and trajectories, and second, in terms of prediction of abnormalities, incidents, or accidents. Training and retraining occur before operations at the start of the system, and during operations, at the occurrence of changes in the environment and of unpredicted events. In this mode, moving patterns are emulated, representations are created and displayed on the screen in front of the supervisor. The deep Q-learning keeps on training being supervised by the expert system in a dual control approach. Simulations may be produced either by algorithms that explore randomly and quasi-exhaustively all potential still unforeseen situations or by human operations by enumerating all specific and strategic situations that have the potential to occur.
2. The operation, meaning to represent and map on the field representation all the information received and decoded in real-time from the telecommunication network. In this working mode, all decoded information is communicated to both the deep Q-learning and expert systems working in dual control. The real-time processing performed by both Q-learning and exert system in dual control may return the proper estimated values of the relevant kinematic parameters, trajectories, and eventually, the term of prediction of abnormalities, incidents, or accidents, all of which being display on the TV screen.

The simulator is permanently connected to a TV screen which displays in the two modes the field of interest, all detected moving patterns labeled with their specific classification and recognition along with some potential alarm setting. The simulator is connected to a data storage which contributes to generating a big data record system including the following:
1. All simulations performed algorithmically or humanly for training and updating the system.
2. All information received and decoded in real-time from the telecommunication network as resulting from the current surveillance activities.

This big data record may be analyzed as background work on given time spans such as daily, weekly, monthly, yearly to discover new unforeseen pattern situations that may be missing in the initial or updating training and help to induce new updates of the system.

The Deep Q-Learning System:

The Deep Q-Learning system works like the unconscious part of the human brain which, after learning and updating from experiments gained from the environment, analyzes and makes fast recognitions and decisions. This part has the essence of a bottom-up approach, that one of empiricism.

The Deep Q-learning system is trained from both the real field and the calibrated simulator before the start of operations, and afterward, at the occurrence of both modifications of the field or unpredicted events. The Deep Q-Learning system receives the field information from the simulator which decodes and locates the information received from the telecommunication network in real-time on the three-dimensional topographic representation of the field. The Deep Q-Learning system receives information from all connected passive and active motion sensors to perform motion classification, trajectory building, prediction of abnormalities, incidents, or accidents. The Deep Q-learning system receives limited stream or motion-related segments of information from video cameras to perform pattern recognition using an established and real-time updated database. All data after analysis are transmitted to the simulator to label all moving patterns on the screen with the recognized characteristics, signal either unclassified or unrecognized patterns or the potentiality of abnormalities, incidents, or accidents.

The Deep Q-learning system is supervised and controlled by the Expert System through an adaptive dual control principle.

The Expert System:

The expert system is divided into two parts as follows.
1. A controlling expert system.
2. A big data analytics expert system.

The Controlling Expert System works like the conscious part of the human brain and makes accurate analysis but at a slower pace than the deep Q-learning. It has the essence of a top-down approach, that one of rationalism. The Controlling Expert System implements the accurate/true models of mechanics (motion) and physics (sensors) taking into account the field topography. The controlling expert System analyzes the motion information with a redundant basis of analyzing functions that constitute of a dictionary to decompose the sensed signals into its motion components. This part refers to the digital signal analysis theory here extended to process signals generated from scattered sensor grids capturing wave transformations that occurred in the field due to motion and in the sensor field of view due to the electronics/photonics effects. The Controlling Expert System may build and then work on an established and updatable database of analyzing functions roughly working as match filters. The analyzing functions are constructions based on Lie group representations of motion and waves as digitized continuous wavelets (Generalization of the Fourier Transform). The kinematic parameter estimation is performed as a filter matching through an inverse problem technique. The analyzing function needs to be calibrated along with the simulator before the start of the system. Motion trajectory construction is based on resolving an Euler-Lagrange Equation which comes to an algorithm. In this algorithm, each trajectory is the locus that optimizes a Lagrangian function through a dynamic programming algorithm that may be rewritten in a recursive form known as Bellman's equation. The dynamic programming algorithm is deep learning implemented in the Q-Learning system all becoming neuro-dynamic programming with Q-learning function as a state of a neural network with approximations leading to a gradient algorithm. For kinematic parameter estimation as well as trajectory building, the controlling system supervises and validates the outcome of the Deep Q-learning in adaptive dual control. In predictable situations, the adaptive control regulates, and the deep Q-learning outcome is prevailing to display the results in the simulator. In situations that become unpredictable, the expert system is taking over with the simulator in order to update and improve the training of the deep Q-learning system and alert the human supervisor of the actions to be taken.

The big-data analytics expert system works on all the past-accumulated data. Over days, weeks, and months, all data produced by the connected sensor network and decoded in the simulator are recorded and archived which generates a big data system. The big-data analytics system performs predictive analytics which consists of extracting information from the existing big data set in order to determine and characterize specific moving behavior patterns and be able to predict future situations, abnormalities, incidents, and accidents and to explore unusual events or situations all with more and more efficiency. The big-data analytics also may produce all forms of customized statistics over a day, a week, a month, and a year ranges.

The Locked Mode:

The locked mode is an additional operative mode of the system where the human supervisor or the artificially intelligent system may focus and freeze on specific moving patterns of interest with the following tools:
1. Add at least one TV screen which may display the video streams coming from the cameras (one or more) which fields of view cover the pattern of interest. The cameras involved in this tracking may keep on changing automatically according to their respective fields of view and the trajectory taken by the moving pattern of interest in order to trace all the tour and be able to react on the moving pattern at any time or any position of its tour.
2. Add TV screens for local moving cameras installed on moving robots, drones, or human security guards.

Freeze mode is a locked control property that comes as an additional capability to the adaptive dual control performed by the deep Q-Learning system and expert system. All data generated by induced freeze mode are recorded for the long term on the big data storage.

Data Fusion and Inverse Problem:

The first step consists of a data fusion to reconstruct the field in “3D+T” by fusing all the data originating from all types of sensors and the video camera along with other data describing the topography of the field. This stage involves a process called the inverse problem to detect and estimate motion parameters of interest from the data produced by the sensor network followed by a process of pattern recognition and motion-based classification. The pattern recognition may be refined and/or completed from the data produced by the video cameras. The first step involves a motion analysis performed by a deep learning neural network and an expert system. The deep learning neural network works and proceeds from the experience acquired during the training and updates which is a bottom-up approach. The expert system works and proceeds from the accurate models derived from the physics of mechanics and waves which is a top-down approach. The expert system operates in parallel to the neural network to implement an accurate model of motion as it takes place in the field taking into account the model of sensors and of the field topography. In this framework, the motion detection and the estimations performed by the neural network are supervised, controlled, and potentially adjusted by the expert system. The deep learning neural network may proceed further to detect, recognize, and characterize incidents, accidents, abnormalities of all kinds (behavioral, intrusion, fire, shots, explosions, etc.)

Active Motion Sensors:

Alternative active sensor techniques of motion sensor networks may be implemented using similar A.I. as the one described earlier, but here locally, in the physical layer. Those sensors aim at scanning the outdoor surroundings and produce images to analyze. In those cases which involve the introduction of one or multiple active sources of waves, minimum information about motion for recognition and parameter states may proceed with the same schemes and procedures of telecommunicating and monitoring in the remote center. Three active motion sensor networks may be considered here which are namely a network of ultrasonic motion sensors (SONAR), a network of microwave motion sensors (RADAR), and a network of laser sensors (LIDAR). Those sensors being located at the physical layer like any other motion sensors require bi-directional transmissions of information: bottom-up with a concentration of sensed motion information towards the remote center and top-down with remote center commands sent to adapt local emission modes. The scene is illuminated by one pulse at a time and an array of pixels measures the time of flight and the intensity of the returning pulse. Compared to video cameras, none of those active systems are presently able to produce high-resolution images and have as well limited object detection capabilities. The use of passive cameras and their moving object detection algorithms are then unavoidable tools to be used with active sensors to describe the motion content. Moreover, it important to notice here that active sensors have shadow areas beyond each detected pattern.

Microwave Motion Sensors (RADAR):

A network of microwave motion sensors may be used indoors for back-up purposes or to cover all outdoor areas of the field. Microwave sensors may be attached to permanent structures. This network set-up requires to install one or more microwave sources in key locations of the field to properly tile the surroundings. Microwave is electromagnetic waves whose frequency bands range from 0.3 GHz to 300 GHz. Microwave sensors and sources work in the whole similarity as ultrasonic corresponding components. Microwave motion sensor networks work as individual sources emitting waves either continuously or with synchronism in form of impulses of programmable in length, in interval delays, and/or in shape. At the reception, the RADAR senses the reflected waves and compare with their background reference, at least, in term of frequency shift (Doppler effect for speed/velocity estimation) with continuous waves, and if more sophisticated, in terms of the time of flight and intensity. After local processing, relevant motion information is transmitted through the telecommunication network to the remote monitoring.

With RADAR and SONAR, there are commonly two operating modes:
1. The Time of Flight operates similarly to the flash LIDAR sensor; however it uses radio-wave pulses for the Time of Flight calculations. Since the sensors are pulsed, the time when the pulse was sent is known with precision as well as the time so computing the range may be easier than the continuous wave sensors. The resolution of the sensor may be adjusted by changing the pulse width and the length of time the sensors listen for a response. Long-range RADAR's tend to use long pulses with long delays between them, and short-range RADAR's use smaller pulses with less time between them. As electronics have improved many RADAR's now may change their pulse repetition frequency, thereby changing their range. These sensors often have fixed antennas leading to a smaller operating field of views compared to LIDAR.
2. There are some systems that may combine multiple ToF radio waves into one package with different pulse widths. These may allow for various ranges to be detected with higher accuracy. These are sometimes referred to as multi-mode RADAR.
3. The Continuous Wave system generates a frequency modulated continuous wave (FMCW) and compares the frequency of the reflected signal to the transmitted signal to measure the frequency shift.

An example of a scanning RADAR data is an image out of a video sequence with 4 cars moving on a road. Resolution is lower compared to LIDAR since it allows for detecting and discriminating each moving object by size/scale and track them separately. Further pattern recognition may require a video camera.

Further, the image associated with the RADAR data may be a plot of bearing angle versus range. Further, the image may include multiple patches. Further, the brightness of a patch indicates the reflected intensity of waves associated with the RADAR. Further, a lower brightness may correspond to an object.

The motion analysis performed by a RADAR shares similarity to what may be produced by a sensor network since it produces an analysis in space and reflected intensity. In this regard, the RADAR image is a wavelet analysis of the field in the angle of view of the RADAR. The image may be segmented into its moving components which depends on the reflectivity properties, and each component tracked. Final recognition requires video camera and sensor fusion. Short distances may be covered by ultrasonic devices. This analysis needs to performed locally at the RADAR site and transmitted to the remote center. The background landscape is known, just the information for recognition, and the information for motion characterization needs to be transmitted.

Unlike other waves, microwave sources may have a narrow beam that imparts it with characteristic features like broad bandwidth and high data transmission. Microwave motion sensors may be used in harsh weather environments, total darkness may also penetrate through walls, holes, and foliage. Microwave motion sensors may be employed to impart coverage across the surroundings. The networking approach with the A.I. system may be able to disambiguate false alarm occurrence better than any other systems in place. Special applications are prisons, banks, warehouses, museums, and more.

Solid-state RADAR-on-a-chip systems are common and small. They have a long-range from 0.3 m to 200 m, but poorer resolution than other sensors. They work equally well in light and dark conditions, and the 76-77 GHz range systems are able to better sense through a fog, rain, and snow, which causes LIDAR and passive visual systems challenges. Current technical performance allows detecting up to 30-35 different objects. Like LIDAR, no color, contrast, or optical character recognition is possible with RADAR. RADAR's are less effective than SONAR at very short distances.

Ultrasonic Motion Sensors (SONAR):

A network of ultrasonic motion sensors is spread in the field or some areas of the field. Ultrasonic sensors are attached to permanent structures in the same way as the photo-detection-based motion sensors. The frequency range normally employed in ultrasonic detection is from 20 KHz to 50 MHz. This active frequency band is higher than any normal human ears sensitivity which is not able to detect those ultrasounds. Normal human ear detection is located in the range of 20 Hz to 20 KHz.

In a general setting, ultrasonic motion sensor networks work with having individual sources emitting impulsive ultrasonic waves in the form of impulses or chirps with programmable frequency, length, interval delays, or patterns. Distributed motion sensors sense the reflected waves and compare them with their background reference, at least, in terms of a difference of time (TOF) and reflected intensity. The technique of an inverse problem is required to estimate the kinematic parameters associated with each moving pattern in terms of position, scale, and orientation at sampling times. The inverse problem technique may be implemented in a general A.I. system based on three-component deep-learning, theoretical model processing, and field simulator. This system is requesting training, calibration, and simulations.

Ultrasonic motion sensor networks may be deployed indoors as a substitute/back-up or in addition to existing photo-electric sensors covering a part of the field of interest. Ultrasonic motion sensor networks are especially useful in applications where photoelectric sensors may not also work to be deployed as a result of the medium like in water or in smoky environments. The velocity of ultrasounds at a particular time and temperature is constant in a medium. Ultrasonic sensors actively emit high-frequency sound above the level of human hearing. They have limited range but are excellent for near-range and three-dimensional mapping. As sound waves are comparatively slow, so differences in a centimeter or less are detectable. They work regardless of light levels, total darkness, and especially, work equally well in all weather conditions of snow, fog, and rain. Like LIDAR and RADAR, they do not provide any color, contrast, or optical character recognition capabilities. They are also useful for gauging speed in applications with a continuous wave. The ultrasonic system is the technique used by bats that generate chirps from their throats with specific ultrasonic frequencies, shapes, lengths, and patterns to measure through their ears the delays and the frequency of the reflected wave. This technique is guiding their flight and insect hunt.

Laser Motion Sensors (LIDAR):

Due to their current limitations, the systems are not useful for detecting anything close by. Current implementations have improved range substantially from early 30 meter ranges up to 150 to 200-meter ranges, with increases in resolution as well in the wavelength range of 600 nm to 1600 nm. At present, production systems with higher range and resolution continue to be expensive. LIDAR works well in all light conditions but starts failing with increases in snow, fog, rain, and dust particles in the air due to its use of light spectrum wavelengths. LIDAR may not detect color or contrast, and may not provide optical character recognition capabilities.

Advanced Scientific Concepts (ASC) is one of the world's leaders in 3D Flash LIDAR cameras. ASC designed the Peregrine family of three-dimensional (3D) Flash LIDAR Video Cameras as lightweight, low power 3D video cameras that output range (point cloud) and intensity in real-time for use in a wide range of applications ranging from aerial mapping to active safety to surveillance. Peregrines are used by automotive companies to evaluate 3D Flash LIDAR cameras for their active safety and autonomous applications such as collision avoidance and lane departure warning systems. The Peregrine's functional description is as follows. The lightweight Peregrine camera is a solid-state 3D staring array LIDAR camera with no moving parts since it is not a scanning LIDAR device other than a fan. Peregrines illuminate an area of interest represented by the field of view of the lens with a single short, as 5 nanoseconds, Class I (eye-safe) laser pulse per frame, and captures the reflected laser light in the form of 3D range point clouds and co-registered intensity data. With 128×32 (or 4,096) pixels and a 4:1 aspect ratio, Peregrine cameras operate up to 20 Hz. Peregrines are configured with a choice of bayonet mount lens options of [60°×15°], [45°×11.25°], [30°×7.5°], and [15°×3.75° ].

An example of a person tracking with a flash LIDAR. As in SONAR and RADAR, the motion analysis performed by a LIDAR share similarity to what may be produced by a motion sensor network since it produces an analysis in space and reflected intensity. In this regard, the LIDAR image generated from a flash or laser impulse is a wavelet-like analysis of the field in the angle of view of the LIDAR. The image may be segmented into its moving components which depends on the reflectivity properties, and each component tracked. Final recognition requires video camera and sensor fusion. Conclusions on Active Sensors: Since each active sensor provides a different type of information about moving patterns of which the sensitivity depends on the environmental conditions several sensors are necessary, and their related information needs to be merged in a sensor fusion process.

A flash LIDAR provides good resolution about a position but may suffer for accuracy in poor weather while a RADAR overall generates less resolution but performs with better accuracy than LIDAR in poor weather. Algorithms used in sensor fusion have to deal with temporal, noisy input and generate a probabilistically sound estimate of the kinematic state. A comparison of all active sensors in terms of range and acuity under different environmental conditions. Acuity is a measure of the spatial resolution of the sensor processing system.

The video camera is referred to as a passive visual as may be a human eye. Camera image recognition systems have recently become very small and high-resolution. The video camera's color, contrast, and optical character recognition capabilities bring a full set of capabilities that are entirely missing from all other sensors. Video cameras have the best range of any sensor but only under good light conditions. In return, the use of passive cameras requires sophisticated object detection algorithms to understand what is visible from the cameras all of which require local computational resources and time.

The classical technique that may be used to track patterns is the Kalman filter which is a powerful sensor fusion algorithm to smooth noisy input and estimate state since it may be completely parameterized by the mean and the covariance with the sate equation without controlling input stimuli.

uₜ=Fₜ₋₁+wₜ

### Where

uₜ is the state vector (position and velocity) at time t
wₜ is the motion vector is the noise term for the state vector with zero mean and variance Qₜ
Fₜ is the state transition matrix

The state vector uₜ holds the position p and velocity v of the moving patterns. Therefore, the

uₜ=(ᵥ^{p}) where p and v are respectively the positions and velocity vectors.

Another technique is to incorporate, after a preprocessing on the sources, the fusion, detection, estimation, and tracking into a deep learning algorithm. The estimation may be performed through a continuous wavelet transform.

$$\begin{matrix}W [ S ( x , t ) ; p τ ; v ; a , r ] = {C}_{ψ}^{- 1 \text{/} 2} 〈 {ψ}_{p , τ ; v ; a , r} \vert S 〉 \\ = {C}_{ψ}^{- 1 \text{/} 2} {\int }_{{ℝ}^{2} \times ℝ} {d}^{n} x dt ψ [ {r}^{- 1} ( \frac{x - p - v}{a} ) , t - τ ] S ( x , t ) \\ = {C}_{ψ}^{- 1 \text{/} 2} {\int }_{{ℝ}^{2} \times ℝ} {d}^{n} k dw \overline{\hat{ψ}} ( {ar}^{- 1} k , w - k . v ) \hat{S} ( k , w )\end{matrix}$$

There are five types of sensors able to provide immediate information of motion out of which three are active sensors namely, LIDAR's, SONAR's, and RADAR's, and two are passive namely video cameras and photodetection motion sensor networks. All sensors are based on measuring the reflected intensity of some specific wave over a given band of frequencies. All active sensors produce wave impulses or wavelets that analyze the field and return a transformed version within a fixed angle of view. Therefore, all active sensors are able to measure a time-of-flight along with corresponding intensity. An active sensor generates a real-time “wavelet” analysis of the field. At sampling times, the intensity of the reflected wave is analyzed and decomposed over the entire field of view through range versus bearing angle. Since all active sensors are poor in resolution, video cameras are unique and unavoidable for pattern recognition and motion disambiguation. But video cameras do not provide information on depth or range in the field. To yield this missing information, the camera pixels have to be spread over the field of interest as small arrays at fixed locations.

All active motion sensors require some sensor fusion at least with a video camera and some time and computation resources to generate a valid motion analysis in their angle of view. It was demonstrated that motion information actually represents less than 1% of the video camera streams. Consequently, a network of video cameras with/or active sensors may first overload the network traffic to the gateway, and, an additional algorithm may be required to compute estimates of the position of the moving patterns, all of which showing that the A.I. may not be as efficient as a motion sensor network and not able to display in real-time as a motion sensor network. Individual video cameras are efficient for pattern recognition and motion disambiguation out of limited segments of their stream. Therefore, all active sensors require a local signal processing to extract the motion content with A.I. algorithm and transmit the limited motion information to the remote monitoring center. The advantage of a distributed network of motion sensors is to provide motion information in real-time without requiring additional processing for tracking. Motion sensor networks are therefore efficient for long term indoor applications since they may be fixed on existing structured, and resulting from weather and adverse conditions, just efficient for short term outdoor motion analysis. Active sensors are efficient solutions to perform long term outdoor motion analysis of the surrounding outdoors or to provide indoors with a short-term back-up. All solution requires video cameras. The use of active sensors is unavoidable to support robot or car autonomous navigation.

Further, the present disclosure describes motion analysis performed from digital data captured by a network of motion sensors distributed over a three-dimensional field of interest. Motion analysis means performing motion detection, motion-oriented classification, estimation, and prediction of kinematic parameters, tracking to build trajectories, and warning of the occurrence of potential abnormalities, incidents, or accidents. Kinematic parameters are defined as spatial and temporal positions, velocity, scale, and orientation. The entire system may be decomposed into three major components. First, a network of sensors captures and generates all relevant motion information. Second, a tree-structured telecommunication system concentrates all motion information to a data sink or gateway. Third, an Artificial Intelligence (A.I.) in a remote monitoring center processes the entire data stream transmitted from the gateway. The A.I. is composed of three major components: a Simulating Software, a Deep Learning System, and an Expert System.

Further, the present disclosure addresses the structural relation between the motion sensor network and artificial intelligence in order to display on a screen a complete and real-time motion analysis of the events taking place in a three-dimensional field of interest. This work may address and compare different motion sensors. The reference network is a network made of motion sensors based on passive photodetection. Other sensor networks of interest are networks based on active detection namely ultrasonic waves (SONAR), microwaves (RADAR), and lasers (LIDAR). A limited amount of video cameras turns out to the unavoidable with any motion sensor networks either active or passive, distributed, or localized. Video cameras are required to produce high-resolution images allowing pattern recognition and motion disambiguation. To conclude, a comparison is presented of different distributed systems that perform motion analysis through different potential technologies for motion sensor networks. To efficiently network in real-time with an A. I., two main challenging questions are raised that are related first to the motion information structure, and second, to the amount to be transmitted. Distributed passive photodetection sensor networks are optimal solutions for long term indoor or short-term outdoor analyses. Active sensor networks are an optimal solution to extend long term motion analysis to the surrounding outdoors.

Further, the present disclosure describes real-time and predictive analytics and remote monitoring. Further, an AI detects suspicious activity on the field. Further, the present disclosure describes a remote monitoring screen facilitating real-time monitoring. Further, the present disclosure describes registering of on-going activities. Further, a monitor staff associated with the remote monitoring screen may access menus through a screen.

Further, the present disclosure describes a remote monitoring screen. Further, the remote monitoring screen may facilitate locking and tracking. Further, the field monitoring may be used to lock on one suspicious target of interest marked in red. Further, video cameras may have a field view of the target area.

Further, the present disclosure describes a system to perform motion analysis on digital signals captured from distributed sensors. Further, the motion analysis may include detection of moving patterns, motion-oriented classification & recognition, estimation of kinematic parameters (position, velocity, scale & orientation), parameter prediction, tracking to build trajectories, detection, identification and prediction of abnormalities, incidents, and accidents, and focusing on patterns of interest. Further, the system may include a passive sensor: a network that collects data from reflected waves (visible, infrared) and active sensors: a source generates a pulse wave (ultrasonic, microwave, infrared) and a network makes measurements on the reflected wave. Further, the system may include a motion sensor network and a video camera. Further, the video camera may be associated with MPEG: 1920×1080 pixels/frame, 10,000-15,000 kbit/s, High definition/continuous stream, and high network traffic load. Further, the motion sensor network may be associated with an array of photodetectors, 1 kbit/message upon detection, locating vertical & horizontal planes with low definition, and low network traffic load.

Realtime and predictive analytics remote monitoring A.I. associated with the system detects suspicious activity on the field. Further, the system may include active motion sensors and video cameras. Further, the video cameras may be associated with high resolution but low sensitivity and data rates and network traffic load. Further, the active motion sensors may be associated with sonars-radar-lidars, measuring time-of-flight and intensity on (x, y) array, and field representation as bearing angle, range, and intensity.

Further, the system may be associated with five sensor network schemes for motion analysis with A.I. Further, motion analysis may include motion detection, motion tracking, and motion prediction.
a. Video Cameras are inevitable: requires adequate preprocessing
i. High resolution for pattern recognition.
ii. Motion disambiguation.
b. Passive and Active Sensor Networks: all provide 3-D representations
i. Reflected intensity response versus (bearing angle, range) or (x,y) & (y,z).
c. Passive Motion Sensor Network: minimum information/without processing:
i. Long term indoor applications (building structure & stable environment).
ii. Short term outdoor applications (weather & batteries).
d. Active Motion Sensor Network: high amount of information/with processing:
i. Long term outdoor applications (weather, wave, and frequency-dependent)
ii. Short term indoor applications (backups but shadowing problems)

Further, the present disclosure describes the system that requires scattering the sampling grid of 3D+T. Earlier, the scattering of the sampling grid includes regular sampling using a video camera sensor array. Further, the scattering of the sampling grid may include irregular sampling using a human eye photodetector mosaic. Further, the scattering of the sampling grid may include sparse sampling using seismology sensor dispersion. Currently, the scattering of the sampling grid may include a sensor network using a sensory system sensor network. Further, the regular sampling using the video camera sensor array may be associated with regular grids, signals and data, digital signal processing, and statistical analysis. Further, incoming visible light passes through the IR-blocking filter of the video camera sensor array. Further, color filters control the color light reaching a sensor. Further, the color blind sensors convert light reaching each sensor into electricity.

Further, the sensor network using the sensory system sensor network may be associated with sensors networks and IoT, big data, deep learning and A.I., and prediction analysis.

Further, the present disclosure describes the system for facilitating performing motion analysis in a field of interest. The field defines a three-dimensional space and time-space of interest to be monitored. Examples of such fields are commercial and business premises, residential, public and administrative buildings, parking garages, transportation stations and undergrounds, airports, private properties/residences, city streets, and battlefields. The fields may be categorized into three main varieties, namely motion-intelligent buildings, cities, and inaccessible grounds.

In this context, the present disclosure presents a prospective approach to motion analysis from digital signal processing. Usual motion analysis means motion detection, motion-based classification, parameter estimation, prediction, and tracking of specific patterns to build trajectories. With the advent of A.I. motion analysis means the detection, indication, and prediction of abnormalities, incidents, and accidents. Focusing further on elected moving patterns of interest stands as the ultimate stage of this analysis.

To derive a general setting for motion analysis through image analysis outline historical progress made from digital signal processing performed on signals sampled on regular sampling grids like pictures and videos to A.I. systems analyzing signals sampled on a scattered network. Video cameras capture signals on a regularly sampled two-dimensional planar grid. The first progress was to break the regularity and obtain an irregular sapling grid like an array of sensors that may eventually not be located planar. The next step was to scatter all the sensors into sets of very small arrays dispersed on a field and to call the resulting scheme a “sensor network”. All sensors are all independent as in the Internet of things and communicate to the central station concentrated through a gateway. The state-of-the-art signal processing has moved to artificial intelligence and supervised learning techniques such as deep learning. The state-of-the-art photodetection has moved to the nanoscale especially with the introduction of quantum dot technology. Those two recent developments of the technology enable moving of the paradigm of the motion analysis that was initially performed through a video camera to the paradigm of an analysis performed from digital signals captured by a sensor network where sensors are spread in the field of interest.

A general setting of this problem may be described as follows. Motion sensors have been distributed in the field. Once released, each motion sensor emits at its own fixed pace a signal which corresponds to some physical variable measured in the field. The sampled information to be transmitted may at least contain identification, array sampled signals, and corresponding timestamp. The source is supposed to introduce motion sensors in the field as long as the experiment is carried on. Several concentrators are located within the perimeter of the measurement field to collect, concentrate, and transmit the information to a single gateway. The gateway generates a single data stream to be communicated to a remote station where a computer processes the analysis. In another setting, motion sensors are fixed on the walls of a construction building and capture all moving light by photodetection.

For indoor applications, the motion analysis may be performed from digital signals captured from numerous sensors distributed in the field. The sensors belong to one of the following categories:

1. Motion sensors are passive photodetectors spread in the field. Their purpose is to analyze and track motion throughout the field of interest through three spectral bands, namely the visible spectrum for optical imaging, the near-infrared for chemical imaging, and the mid-infrared for thermal imaging.

2. Multiple video cameras are located on key locations or embarked on moving systems such as robots. Their purpose is to provide high-resolution images and videos for final pattern recognition and motion disambiguation.

Parameter estimation means the determination of the kinematic parameters of moving items along their time parametrized trajectory. Kinematic parameters of interest are velocity, space and time position, orientation, and scale. Further, motion is described by a model originating from classical mechanics. This model is based on group theory since the algebraic structure and law of composition of kinematic parameters is a Lie group. Group representations lead to building analyzing functions in the functional space of the captured signals. Those analyzing functions refer to digitized continuous wavelets that are endowed with the optimal properties to perform the detection and the estimation of kinematic parameters. The model is based on wavelet representations that perform detection and parameter estimation in the functional space of the signals that are generated by moving objects and captured by the sensors. In this case, the model originates from classical mechanics defined on some given geometry. In classical mechanics, motion is ruled by a Lie group called the Galilei group. The Galilei group has the property to provide the representations in the Hilbert space of the captured signals. When well defined, those representations have the optimal analyzing properties that enable performing motion parameter estimation. Those representations have in fact the properties to be unitary, irreducible, and square-integrable and to enable the existence of admissible continuous wavelets that are the best fit for motion analysis in multidimensional space and time.

Since motion analysis may rely on the model of the actual physics that takes place in the field, the analysis may proceed through a so-called inverse problem. The inverse problem is the process of calculating from a set of measurements the causal factors that produced them under the condition that a perfect model is known to relate the causal factors and the measurement data. The application of an inverse problem to perform estimation as the result of measurements requires the following:

1. A model of the system under investigation. In this case, the model is the laws of analytical mechanics that provide a structure for the motion parameters. This structure is a Lie group called the Galilei group for obvious reasons.

2. A theory linking the parameters of the model to the functions or data to be measured. The parameters have the property to compose and define a Lie group. The theory of interest is based on functional representations for the Galilei group in an inner product space called the Hilbert space. The theory is based on the quantum mechanics idea that each moving object is associated with a wave. The theory of quantum mechanics applies to any Lie group, and in particular, on the Galilei group as long as perfect representations may be constructed as analyzing tools in the functional space of interest. Those analyzing tools come in the form of frames that constitute a dictionary of redundant bases.

It turns out that the group theoretical approach is a theory that is implied in the process of pattern recognition. Indeed, group theory is a theory that defines invariants through transformations. This invariance is exactly what is expected from a recognition system that may be able to recognize a pattern independently of its scale, orientation, and other transformations. Also, the parameter estimation process and the tracking fit into the deep learning process. Further, a properly distributed network of motion sensor based on passive photodetection operates like a SONAR, RADAR or LIDAR by mapping the three-dimensional space (x, y, z) of interest in term of two projections planes. Two sampling grids, the first along (x, y) and the second along (z, y) are both providing, at exact and fixed positions, the reflected light intensity at sampling time. Further, the motion sensor system needs a video camera located in a key location to capture images that perform pattern recognition and motion disambiguation. For the same reasons, each active sensor mentioned above requires each video camera and data fusion.

Further, the present disclosure may describe an A.I. system fit for the motion sensor network. Each system either local active or distributed passive requires its own dedicated A.I. to detect, estimate, and track moving patterns.

Further, the present disclosure relates generally to a system of motion sensors. More specifically, the present disclosure describes a system of motion sensors, telecommunication systems, and A.I. that capture data and display on a screen for analysis.

Further, the present disclosure describes five types of sensors for motion analysis with A.I. Further, the five types of sensors may include video cameras, motion sensor networks, radars, lidars (also/equivalent to called ToF (ToF means Time of Flight) cameras), and sonars. Further, the video cameras may be used in an indoor environment and an outdoor environment of the filed of interest. Further, the video cameras may provide a high-resolution image for pattern recognition. Further, the video cameras may perform motion disambiguation. Further, the video cameras may require adequate preprocessing.

Further, passive motion sensor networks and active sensors may provide 3-D representations. Further, the 3-D representations may include reflected intensity response versus (bearing angle, range) or versus (x,y) & (y,z). Further, the 3-D may be in a forms of reflected intensity response versus (x,y) & (y,z) meaning vertical and horizontal projections (two orthogonal projections sufficient and necessary to represent 3-D). Further, a passive motion sensor network involves minimum motion information and does not require local preprocessing (digital signal processing not AI). Further, the passive motion network may include a high sensitivity to change of contrast/reflected intensity. Further, the passive motion sensor network may be used for long term indoor applications since building structure & a stable environment. Further, an active motion sensor network may include Sonar, radar, Lidars. Further, the active motion sensor may involve a high amount of information and requires local processing. Further, the active sensor network may be independent of the level of ambient illumination. Further, the active sensor network may be used for long term outdoor applications. Further, sonars may be associated with high resolutions and short distances. Further, the sonars may be sensitive to foliage moving. Further, lidars may be associated with low resolution. Further, the lidars may be highly dependent on inclement weather. Further, radars may be associated with low resolution. Further, the radars may be independent of inclement weather (rain, fog, and snow), smoke, and moving foliage. Further, the radars may allow long-range sensitivity (usual up to 150 meters but can extend much further). Further, in indoor applications radars are used to provide redundancy to the motion sensor network.

Further, video cameras, motion sensor networks, and domestic radars may be associated with an indoor environment. Further, video cameras, radars (on limited spots (locally)), and motion sensor networks may be associated with an outdoor environment.

A radar for domestic application generates different graph: 1. range versus relative speed By short term FFT, 2. Distance along Y versus distance along X (2D Radars) computed from the information of range and bearing angle) 3. Distance along Z versus distance along X (additional to have 3D Radars) computed from information of range and elevation angle). Further, 1, 2, 3 is the preprocessing performed locally at radar x times per second and transmitted to AI located in the remote monitoring center.

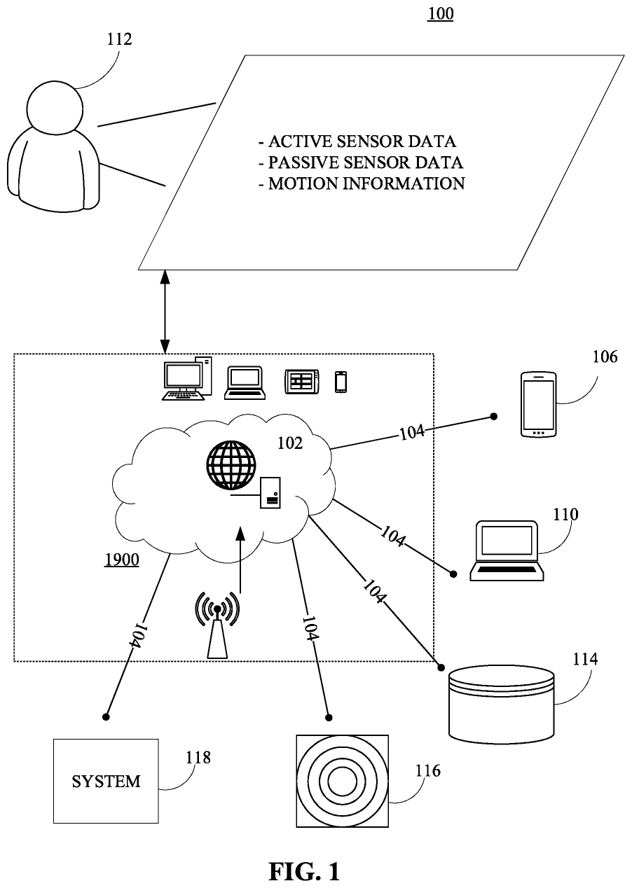

FIG. 1 is an illustration of an online platform 100 consistent with various embodiments of the present disclosure. By way of non-limiting example, the online platform 100 to facilitate performing of motion analysis in a field of interest may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, sensors 116, and a system 118 (such as a system 200 and a system 300) over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 1900.

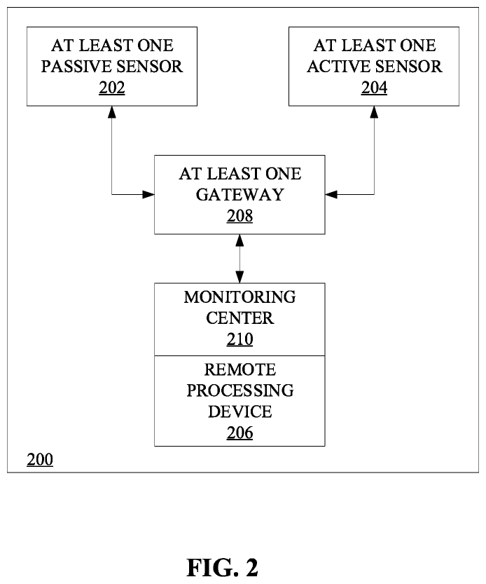

FIG. 2 is a block diagram of a system 200 for facilitating performing of motion analysis in a field of interest, in accordance with some embodiments. Further, the system 200 may include at least one passive sensor 202, at least one active sensor 204, at least one gateway 208, and a remote monitoring center 210.

Further, the at least one passive sensor 202 may be disposed in the field of interest. Further, the field of interest may include at least one object associated with at least one motion. Further, the at least one passive sensor 202 may be configured for generating passive sensor data based on receiving of first waves associated with the field of interest.

Further, the at least one active sensor 204 may be disposed in the field of interest. Further, the at least one active sensor 204 may be configured for producing second waves. Further, the second waves may be configured for reflecting of the at least one object based on the producing. Further, the at least one active sensor 204 may be configured for receiving transformed waves based on the reflecting. Further, the at least one active sensor 204 may be configured for generating active sensor data based on the receiving of the transformed waves. Further, the at least one active sensor 204 may include at least one motion sensor. Further, the at least one active sensor 204 may include an ultrasonic motion sensor (SONAR), a microwave motion sensor (RADAR), a laser sensor (LIDAR), etc.

Further, the at least one gateway 208 may be disposable proximal to the field of interest. Further, the at least one gateway 208 may be configured as a two-way interface capable of communicating with the remote monitoring center 210, the at least one passive sensor 202, and the at least one active sensor 204. Further, the at least one gateway 208 may be configured for transmitting the passive sensor data and the active sensor data to the remote monitoring center 210. Further, the remote monitoring center 210 may be configured for performing the motion analysis. Further, the remote monitoring center 210 may include a remote processing device 206. Further, the remote processing device 206 may be configured for combining the passive sensor data and the active sensor data. Further, the remote processing device 206 may be configured for generating motion information based on the combining.

Further, in some embodiments, at least one of the at least one active sensor 204 and the at least one passive sensor 202 may be associated with at least one field of view. Further, the at least one field of view may include at least one spatial region of the field of interest within which the at least one motion of the at least one object may be detectable by the at least one of the at least one active sensor 204 and the at least one passive sensor 202.

In further embodiments, a local processing device may be communicatively coupled with the at least one active sensor 204. Further, the at least one gateway 208 may be communicatively coupled with the local processing device. Further, the local processing device may be configured for preprocessing the active sensor data. Further, the local processing device may be configured for extracting first active sensor data from the active sensor data based on the preprocessing. Further, the at least one gateway 208 may be configured for transmitting the first active sensor data to the remote monitoring center 210. Further, the remote processing device 206 may be configured for combining the first active sensor data and the passive sensor data. Further, the generating of the motion information may be based on the combining of the first active sensor data and the passive sensor data.

Further, in some embodiments, at least one of the at least one passive sensor 202 and the at least one active sensor 204 may be disposed as at least one network in the field of interest. Further, the at least one active sensor 204 may be associated with at least one active motion sensor network. Further, the at least one active motion sensor network may include a network of ultrasonic motion sensor (SONAR), a network of microwave motion sensor (RADAR), and a network of laser sensor (LIDAR). Further, the at least one passive sensor 202 may be associated with at least one passive motion sensor network.

Further, in some embodiments, each of the at least one active sensor 204 and the at least one passive sensor 202 may be associated with a resolution and a sensitivity. Further, the at least one active sensor 204 may include at least one active sensor resolution and at least one active sensor sensitivity. Further, the at least one passive sensor 202 may include at least one passive sensor resolution and at least one passive sensor sensitivity. Further, the at least one active sensor resolution may be higher than the at least one passive sensor resolution. Further, the at least one active sensor sensitivity may be lower than the at least one passive sensor sensitivity.

Further, in an embodiment, the at least one active sensor resolution may be lower than the at least one passive sensor resolution. Further, the at least one active sensor sensitivity may be higher than the at least one passive sensor sensitivity.

Further, in an embodiment, the passive sensor data corresponds to at least one of the resolution and the sensitivity of the at least one passive sensor 202. Further, the active sensor data corresponds to at least one of the resolution and the sensitivity of the at least one active sensor 204. Further, the combining of the passive sensor data and the active sensor data may be based on at least one of the resolution and the sensitivity of each of the at least one active sensor 204 and the at least one passive sensor 202.

Further, in some embodiments, the at least one passive sensor 202 may include a plurality of passive motion sensors. Further, the plurality of passive motion sensors and at least one video camera may be communicatively coupled with a local processing device. Further, the local processing device may be communicatively coupled with the at least one gateway 208. Further, the plurality of passive motion sensors and the at least one video camera may be disposed of in an indoor environment of the field of interest. Further, each video camera may be configured to capture image sequences associated with a portion of the field of interest. Further, the local processing device may be configured for preprocessing the image sequences. Further, the at least one gateway 208 may be configured for transmitting the image sequences to the remote monitoring center 210 based on the preprocessing. Further, the remote processing device 206 may be configured for combining the image sequences and the passive sensor data based on the preprocessing. Further, the generating of the motion information may be based on the combining of the image sequences and the passive sensor data.

Further, in some embodiments, the at least one passive sensor 202 may include a plurality of passive motion sensors. Further, the plurality of passive motion sensors and the at least one active sensor 204 may be communicatively coupled with a local processing device. Further, the local processing device may be communicatively coupled with the at least one gateway 208. Further, the plurality of passive motion sensors and the at least one active sensor 204 may be disposed of in an indoor environment of the field of interest. Further, each active sensor may be configured to capture the active sensor data associated with a portion of the field of interest. Further, the local processing device may be configured for preprocessing the active sensor data. Further, the at least one gateway 208 may be configured for transmitting the active sensor data to the remote monitoring center 210 based on the preprocessing. Further, the remote processing device 206 may be configured for combining the active sensor data and the passive sensor data based on the preprocessing. Further, the generating of the motion information may be based on the combining of the active sensor data and the passive sensor data.

Further, in some embodiments, the at least one active sensor 204 may include a plurality of active motion sensors. Further, the plurality of active motion sensors and at least one video camera may be communicatively coupled with a local processing device. Further, the local processing device may be communicatively coupled with at least one gateway 208. Further, the plurality of active motion sensors and the at least one video camera may be disposed of in an outdoor environment of the field of interest. Further, each video camera may be configured to capture image sequences associated with a portion of the field of interest. Further, the local processing device may be configured for preprocessing the image sequences and the active sensor data. Further, the at least one gateway 208 may be configured for transmitting the image sequences and the active sensor data to the remote monitoring center 210. Further, the remote processing device 206 may be configured for combining the image sequences and the active sensor data based on the preprocessing. Further, the generating of the motion information may be based on the combining of the image sequences and the active sensor data.

Further, in some embodiments, the at least one passive sensor 202 may include a plurality of passive motion sensors. Further, the plurality of passive motion sensors and the at least one active sensor 204 may be communicatively coupled with a local processing device. Further, the local processing device may be communicatively coupled with the at least one gateway 208. Further, the plurality of passive sensors and the at least one active sensor 204 are disposed of in an outdoor environment of the field of interest. Further, each active sensor may be configured to capture the active sensor data associated with a portion of the field of interest. Further, the local processing device may be configured for preprocessing the active sensor data. Further, the at least one gateway 208 may be configured for transmitting the active sensor data to the remote monitoring center 210. Further, the remote processing device 206 may be configured for combining the active sensor data and the passive sensor data based on the preprocessing. Further, the generating of the motion information may be based on the combining of the active sensor data and the passive sensor data.

Further, in an embodiment, the at least one active sensor 204 may include a radar. Further, the preprocessing associated with the radar may include generating a plurality of graphs. Further, a first graph of the plurality of graphs may include range versus relative speed. Further, the first graph may be generated by performing short term FFT (Fast Fourier transform). Further, a second graph of the plurality of graphs may include a distance along the Y-axis versus a distance along the X-axis (2D radars). Further, the second graph may be computed from the information of range and bearing angle associated with the field of interest. Further, a third graph of the plurality of graphs may include a distance along the Z-axis versus a distance along the X-axis (additional to 3D radars). Further, the third graph may be computed from the information of range and elevation angle associated with the field of interest.

Further, in some embodiments, the at least one active sensor 204 may be associated with at least one first field of view and the at least one passive sensor 202 may be associated with at least one second field of view. Further, the at least one first field of view and the at least one second field of view intersect to form at least one overlapping region. Further, the passive sensor data and the active sensor data may be associated with the at least one overlapping region.

Further, in some embodiments, each of the passive sensor data and the active sensor data may include at least one type of at least one information of the at least one object. Further, the at least one type of the at least one information may include positional information, visual information, thermal information, size information, orientation information, scale information, etc. Further, the combining of the passive sensor data and active sensor data may be based on the at least one type of the at least one information.

Further, in some embodiments, at least one of the at least one active sensor 204 and the at least one passive sensor 202 may be configured for mapping the field of interest. Further, the field of interest may include a three-dimensional space. Further, the mapping may include generating at least one three-dimensional representation of the three-dimensional space. Further, the at least one three-dimensional representation may include a reflected intensity response associated with the three-dimensional space versus at least two orthogonal projections associated with the three-dimensional space. Further, the generating of the passive sensor data may be based on the mapping. Further, the generating of the active sensor data may be based on the mapping.

Further, in some embodiments, the at least one passive sensor 202 and the at least one active sensor 204 may be configured for generating the passive sensor data and the active sensor data synchronously.

Further, in some embodiments, the at least one passive sensor 202 and the at least one active sensor 204 may be configured for generating the passive sensor data and the active sensor data asynchronously.

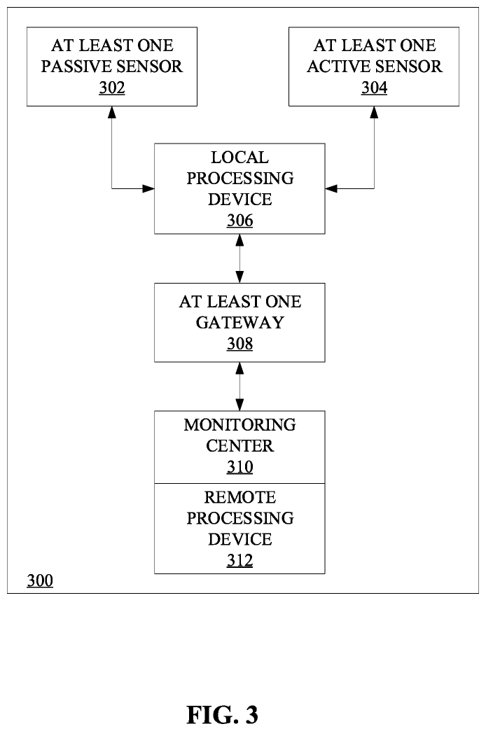

FIG. 3 is a block diagram of a system 300 for facilitating performing of motion analysis in a field of interest, in accordance with some embodiments. Further, the system 300 may include at least one passive sensor 302, at least one active sensor 304, a local processing device 306, at least one gateway 308, and a remote monitoring center 310.

Further, the at least one passive sensor 302 may be disposed in the field of interest. Further, the field of interest may include at least one object associated with at least one motion. Further, the at least one passive sensor 302 may be configured for generating passive sensor data based on receiving of first waves associated with the field of interest.

Further, the at least one active sensor 304 may be disposed in the field of interest. Further, the at least one active sensor 304 may be configured for producing second waves. Further, the second waves may be configured for reflecting of the at least one object based on the producing. Further, the at least one active sensor 304 may be configured for receiving transformed waves based on the reflecting. Further, the at least one active sensor 304 may be configured for generating active sensor data based on the receiving of the transformed waves.

Further, the local processing device 306 may be communicatively coupled with the at least one passive sensor 302 and the at least one active sensor 304. Further, the local processing device 306 may be configured for preprocessing the active sensor data. Further, the local processing device 306 may be configured for extracting first active sensor data from the active sensor data based on the preprocessing.

Further, the at least one gateway 308 may be disposable proximal to the field of interest. Further, the at least one gateway 308 may be configured as a two-way interface capable of communicating with the remote monitoring center 310 and the local processing device 306. Further, the at least one gateway 308 may be configured for transmitting the first active sensor data and the passive sensor data to the remote monitoring center 310. Further, the remote monitoring center 310 may be configured for performing the motion analysis. Further, the remote monitoring center 310 may include a remote processing device 312. Further, the remote processing device 312 may be configured for combining the passive sensor data and the first active sensor data. Further, the remote processing device 312 may be configured for generating motion information based on the combining.

Further, in some embodiments, at least one of the at least one active sensor 304 and the at least one passive sensor 302 may be associated with at least one field of view. Further, the at least one field of view may include at least one spatial region of the field of interest within which the at least one motion of the at least one object may be detectable by the at least one of the at least one active sensor 304 and the at least one passive sensor 302.

Further, in some embodiments, at least one of the at least one passive sensor 302 and the at least one active sensor 304 may be disposed as at least one network in the field of interest. Further, the at least one active sensor 304 may be associated with at least one active motion sensor network. Further, the at least one active motion sensor network may include a network of ultrasonic motion sensor (SONAR), a network of microwave motion sensor (RADAR), and a network of laser sensor (LIDAR). Further, the at least one passive sensor 302 may be associated with at least one passive motion sensor network.

Further, in some embodiments, each of the at least one active sensor 304 and the at least one passive sensor 302 may be associated with a resolution and a sensitivity. Further, the at least one active sensor 304 may include at least one active sensor resolution and at least one active sensor sensitivity. Further, the at least one passive sensor 302 may include at least one passive sensor resolution and at least one passive sensor sensitivity. Further, the at least one active sensor resolution may be higher than the at least one passive sensor resolution. Further, the at least one active sensor sensitivity may be lower than the at least one passive sensor sensitivity.

Further, in an embodiment, the at least one active sensor resolution may be lower than the at least one passive sensor resolution. Further, the at least one active sensor sensitivity may be higher than the at least one passive sensor sensitivity.

Further, in an embodiment, the passive sensor data corresponds to at least one of the resolution and the sensitivity of the at least one passive sensor 302. Further, the active sensor data corresponds to at least one of the resolution and the sensitivity of the at least one active sensor 304. Further, the combining of the passive sensor data and the first active sensor data may be based on at least one of the resolution and the sensitivity of each of the at least one active sensor 304 and the at least one passive sensor 302.

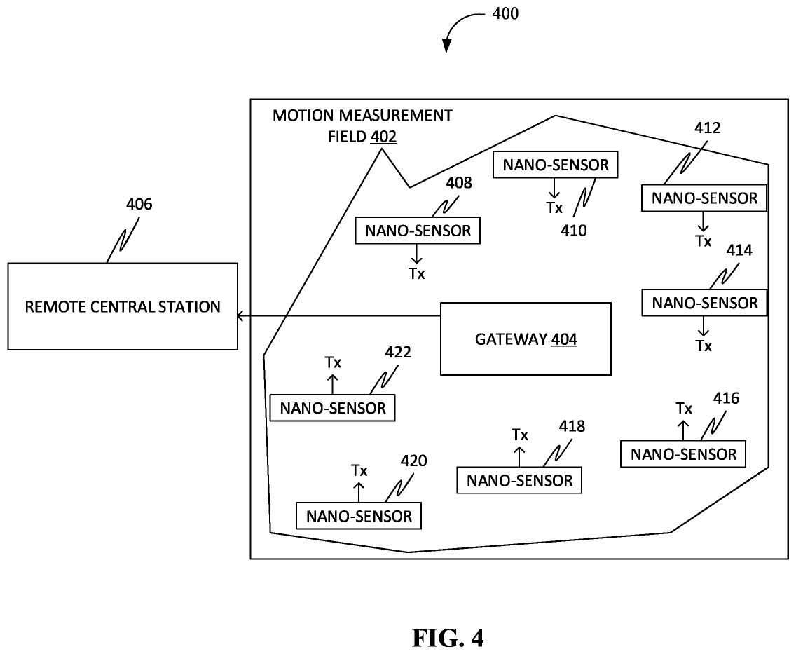

FIG. 4 is a schematic of a motion sensor system 400 for facilitating motion analysis, in accordance with some embodiments. Further, the motion sensor system 400 may include a plurality of sensors 408-422, a gateway 404, and a remote central station 406.

Further, the plurality of sensors 408-422 may be disposed of on a motion measurement field 402. Further, the field of interest may include the motion measurement field 402. Further, the plurality of sensors 408-422 may be scattered into sets of small arrays for dispersing in the motion measurement field 402. Further, the plurality of sensors 408-422 may be dispersed in a scheme forming a sensor network. Further, the plurality of sensors 408-422 may be independent. Further, the plurality of sensors 408-422 may include the Internet of things. Further, the plurality of sensors 408-422 may be configured to communicate to the remote central station 406 through the gateway 404. Further, the plurality of sensors 408-422 may include at least one active sensor (such as the at least one active sensor 204 and the at least one active sensor 304) and at least one passive sensor (such as the at least one passive sensor 202 and the at least one passive sensor 302). Further, the plurality of sensors 408-422 may include a plurality of nano-sensors. Further, the remote monitoring may include the remote central station 406.

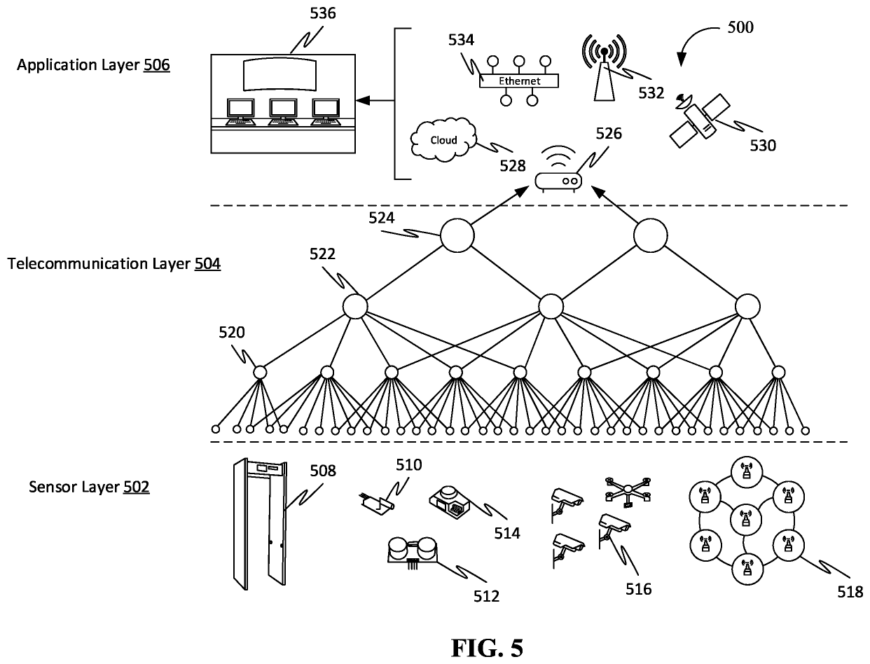

FIG. 5 is a schematic of a motion-intelligent system 500 for facilitating motion analysis, in accordance with some embodiments. Further, the motion-intelligent system 500 may include at least three layers. Further, the at least three layers may include a sensor layer 502, a telecommunication layer 504, and an application layer 506.

Further, the sensor layer 502 may include at least one marking sensor network, at least one active motion sensor network, at least one video camera 516, and at least one motion sensor network 518. Further, the at least one marking sensor network may include at least one walk-through detector 508, at least one active badge, at least one biometric and FRS. Further, the at least one active motion sensor network may include at least one laser sensor 510, at least one microwave sensor 514, at least one ultrasonic sensor 512. Further, the sensor layer 502 may include a lower-physical layer associated with the motion-intelligent system 500. Further, the sensor layer 502 may facilitate detection and measurement of motion.

Further, the telecommunication layer 504 may include at least one sub-router 520-522 and at least one router 524. Further, the telecommunication layer 504 may be configured to transmit information associated with the sensor layer 502. Further, the at least one sub-router 520-522 and the at least one router 524 may be configured for carrier generation, modulation and frequency selection to transmit the information. Further, the telecommunication layer 504 may include an upper physical layer of the motion-intelligent system 500. Further, the telecommunication layer 504 may include a data-link layer of the motion-intelligent system 500. Further, the telecommunication layer 504 may include a network layer of the motion-intelligent system 500.

Further, the application layer 506 may include a transport layer of the motion-intelligent system 500. Further, the transport layer may include the Internet, radio communication, and satellite communications. Further, the application layer 506 may include a Cloud 528, workstations. Further, the application layer 506 may be specialized in Artificial Intelligence especially in deep learning neural networks. Further, the application layer 506 may include a remote monitoring center 536, an Ethernet 534, a radio tower 532, a gateway 526, and a satellite 530.

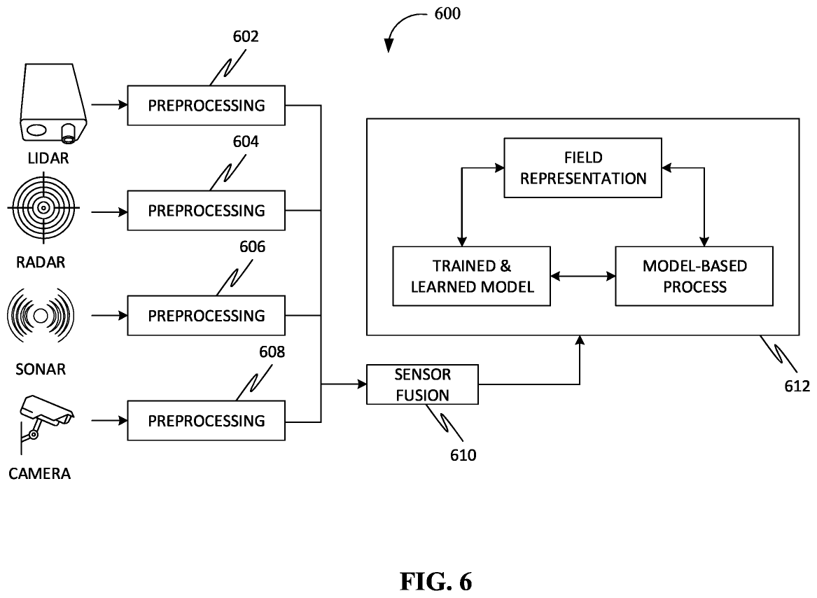

FIG. 6 is a flow diagram of a method 600 for facilitating sensor fusion and parameter estimation, in accordance with some embodiments. Further, the method 600 may facilitate outdoor motion analysis. Further, at 602, the method 600 may include preprocessing first information associated with a LIDAR. Further, at 604, the method 600 may include preprocessing second information associated with a RADAR. Further, at 606, the method 600 may include preprocessing third information associated with a SONAR. Further, at 608, the method 600 may include preprocessing fourth information associated with a camera. Further, at 610, the method 600 may include sensor fusion. Further, the sensor fusion may include combining the first information, the second information, the third information, and the fourth information. Further, the sensor fusion may include using algorithms for dealing temporal, noisy input and generating a probabilistically sound estimate of a kinematic state. Further, at 612, the method 600 may include estimating a state based on the sensor fusion. Further, the estimating may use field representation, trained and learned model, and model-based process.

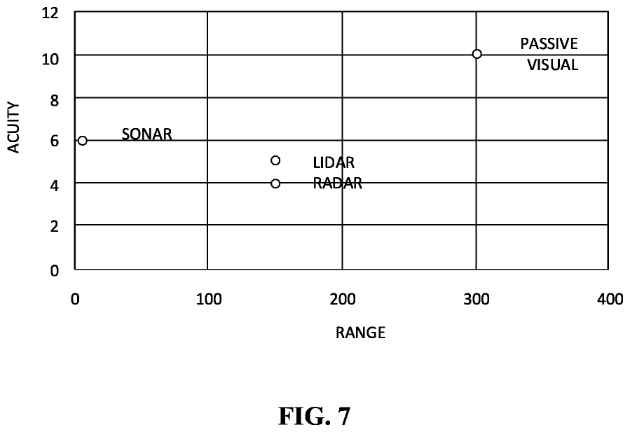

FIG. 7 is a graphical representation of acuity versus range for a plurality of sensors in an environmental condition, in accordance with some embodiments. Further, the graphical representation illustrates a comparison of a plurality of active sensors and a passive visual sensor. Further, the passive visual sensor may be a reference for the plurality of active sensors. Further, the environmental condition may include a clear and well-lit condition. Further, the plurality of active sensors may include a SONAR, a LIDAR, and a RADAR.

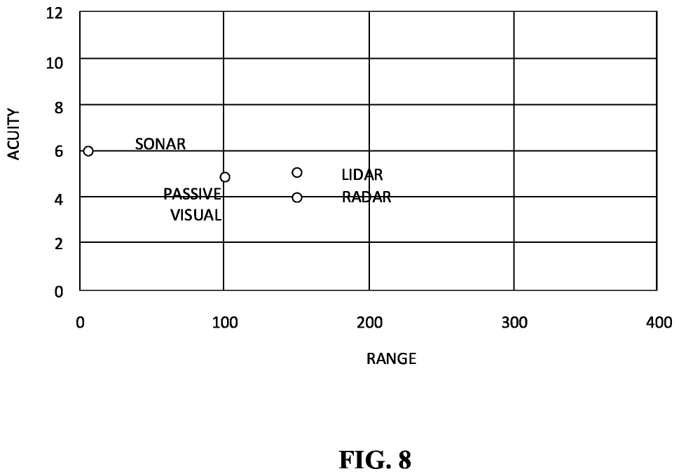

FIG. 8 is a graphical representation of acuity versus range for a plurality of sensors in an environmental condition, in accordance with some embodiments. Further, the graphical representation illustrates a comparison of a plurality of active sensors and a passive visual sensor. Further, the passive visual sensor may be a reference for the plurality of active sensors. Further, the environmental condition may include a clear and dark condition. Further, the plurality of active sensors may include a SONAR, a LIDAR, and a RADAR.

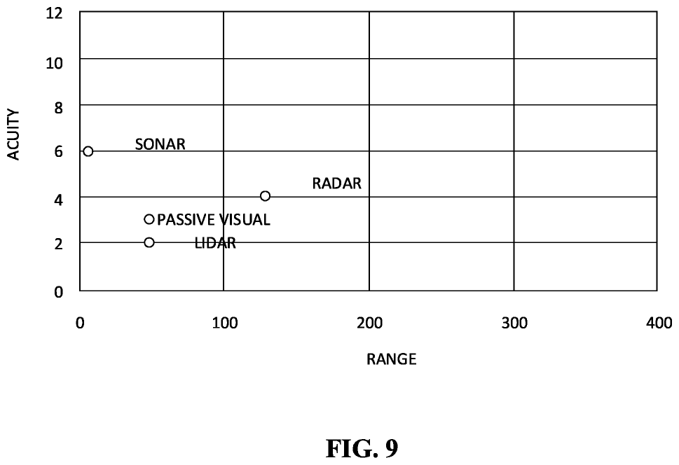

FIG. 9 is a graphical representation of acuity versus range for a plurality of sensors in an environmental condition, in accordance with some embodiments. Further, the graphical representation illustrates a comparison of a plurality of active sensors and a passive visual sensor. Further, the passive visual sensor may be a reference for the plurality of active sensors. Further, the environmental condition may include a heavy rain and snow or fog condition. Further, the plurality of active sensors may include a SONAR, a LIDAR, and a RADAR.

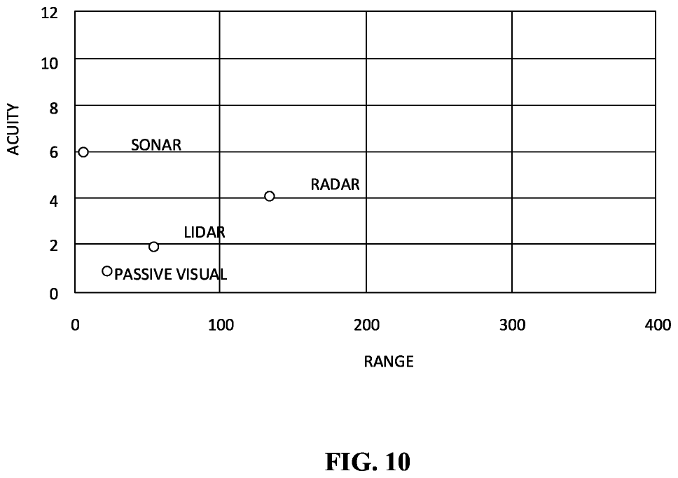

FIG. 10 is a graphical representation of acuity versus range for a plurality of sensors in an environmental condition, in accordance with some embodiments. Further, the graphical representation illustrates a comparison of a plurality of active sensors and a passive visual sensor. Further, the passive visual sensor may be a reference for the plurality of active sensors. Further, the environmental condition may include a heavy rain, snow or fog, and dark condition. Further, the plurality of active sensors may include a SONAR, a LIDAR, and a RADAR.

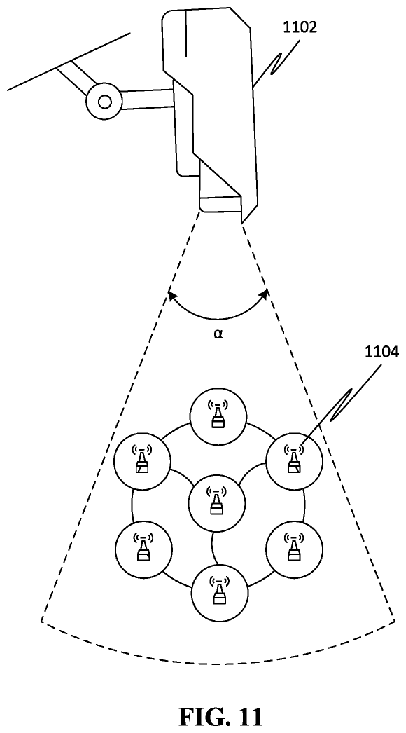

FIG. 11 is schematic of a motion sensor network 1104 and a camera 1102 in an arrangement, in accordance with some embodiments. Further, the camera 1102 may be associated with a field of view. Further, the field of view may include an angle of view. Further, the motion sensor network 1104 may be disposed within the field of view and the angle of view.

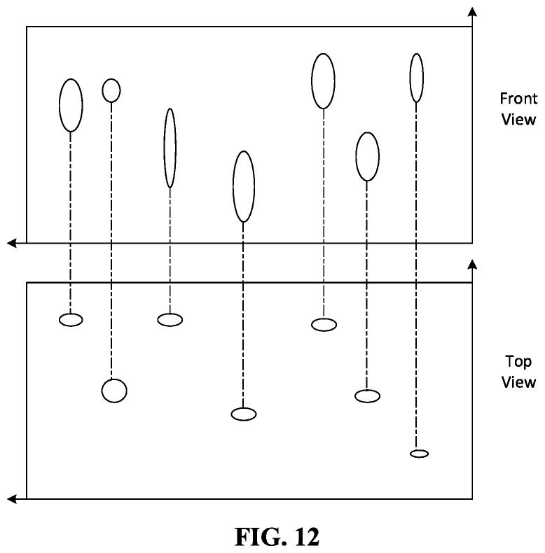

FIG. 12 is an illustration of projections of a field of interest, in accordance with some embodiments. Further, the projections may include a horizontal projection and a vertical projection. Further, the projections may include a front view and a top view of the field of interest.

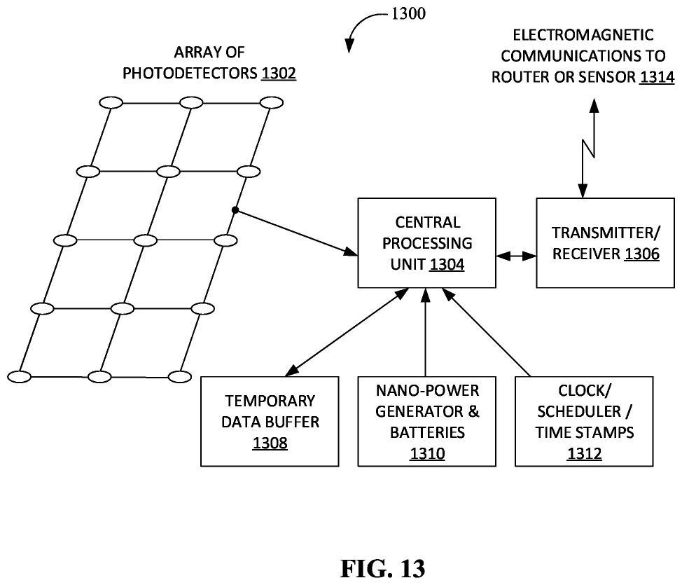

FIG. 13 is a schematic of a system 1300 for facilitating motion sensor functions, in accordance with some embodiments. Further, the system 1300 may include an array of photodetector 1302, a central processing unit 1304, a transmitter/receiver 1306, a temporary data buffer 1308, nano-power generator and batteries 1310, clock/scheduler/time stamps 1312, a router or sensor 1314. Further, the transmitter/receiver 1306 may communicate with the router or sensor 1314 through electromagnetic communication.

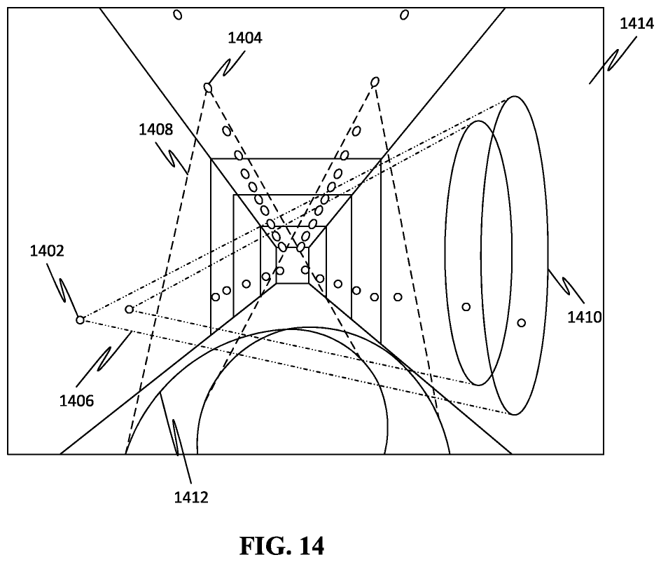

FIG. 14 is a schematic of a plurality of sensors 1402-1404 disposed on a field of interest 1414, in accordance with some embodiments. Further, the plurality of sensors 1402-1404 may be associated with a plurality of field of views. Further, the plurality of field of views may include at least one horizontal view 1408 and at least one vertical view 1406. Further, the at least one horizontal view 1408 may include at least one horizontal projection 1412. Further, the at least one vertical view 1406 may include at least one vertical projection 1410.

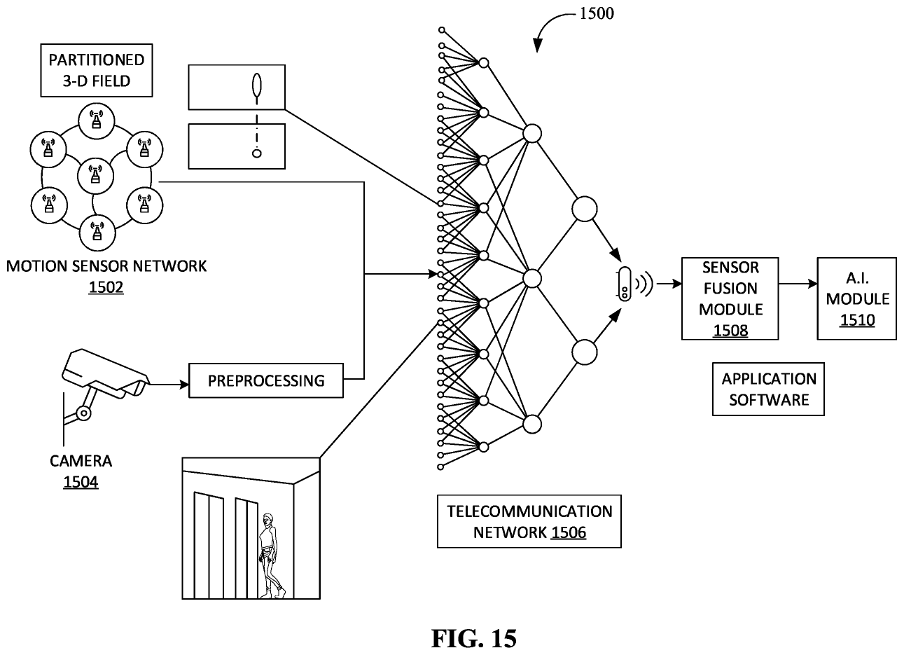

FIG. 15 is a schematic of a system 1500 for facilitating motion analysis, in accordance with some embodiments. Further, the motion analysis may include indoor motion analysis. Further, the system 1500 may include a motion sensor network 1502, a camera 1504, a telecommunication network 1506, a sensor fusion module 1508, and an artificial intelligence (A.I.) module 1510.

Further, the motion sensor network 1502 may be configured for generating projections associated with a 3D partitioned field. Further, the camera 1504 may be configured for generating images associated with the 3D partitioned field. Further, the camera 1504 may be configured for preprocessing the images. Further, the motion sensor network 1502 and the camera 1504 may be communicatively coupled with the telecommunication network 1506. Further, the sensor fusion module 1508 may be communicatively coupled with the telecommunication network 1506. Further, the artificial intelligence module 1510 may be communicatively coupled with the sensor fusion module 1508. Further, the sensor fusion module 1508 may be configured for fusing the projections and the images using the artificial intelligence module 1510.

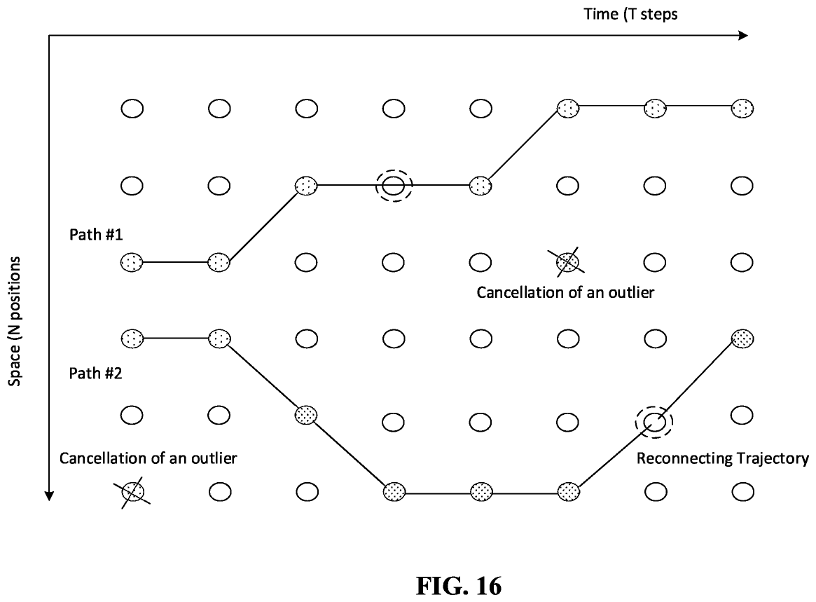

FIG. 16 is a graphical representation of neuro-dynamic programming for facilitating motion analysis, in accordance with some embodiments.

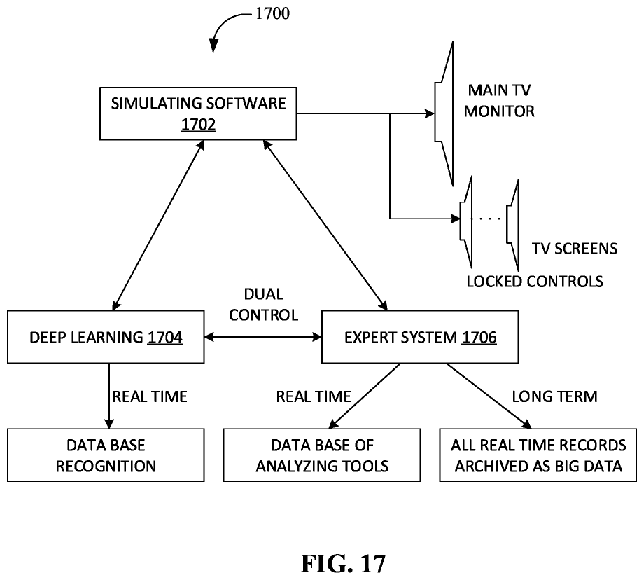

FIG. 17 is a schematic describing an artificial intelligence software 1700 for facilitating motion analysis, in accordance with some embodiments. Further, the artificial intelligence software 1700 may include a simulating software 1702, a deep learning 1704, and an expert system 1706. Further, the simulating software 1702 interfaces with the deep learning 1704 and the expert system 1706. Further, the deep leaning 1704 and the expert system 1706 interfaces using dual control. Further, the deep learning 1704 may be associated with database recognition. Further, the expert system 1706 may be associated with a database of analyzing tools. Further, the expert system 1706 may be associated with all real-time records as big data.

Further, the simulating software 1702 interfaces with a main television (TV) monitor. Further, the simulating software 1702 interfaces with television (TV) screens. Further, the television screens may be associated with locked controls.

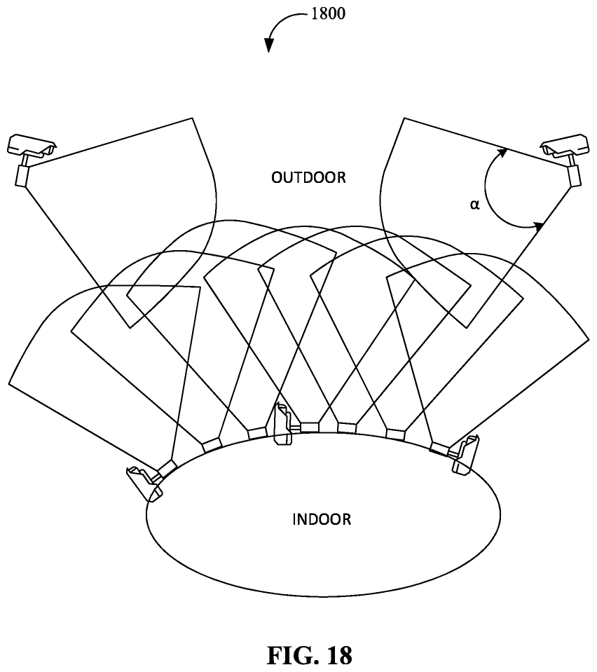

FIG. 18 is schematic of an active motion sensor network 1800, in accordance with some embodiments. Further, the active motion sensor network 1800 may be disposed of in a field of interest. Further, the field of interest may include an outdoor and an indoor. Further, an active motion sensor of the active motion sensor network 1800 may be associated with a field of view. Further, the field of view may include an angle of view. Further, cameras associated the active motion sensor network 1800 may share the angle of view.

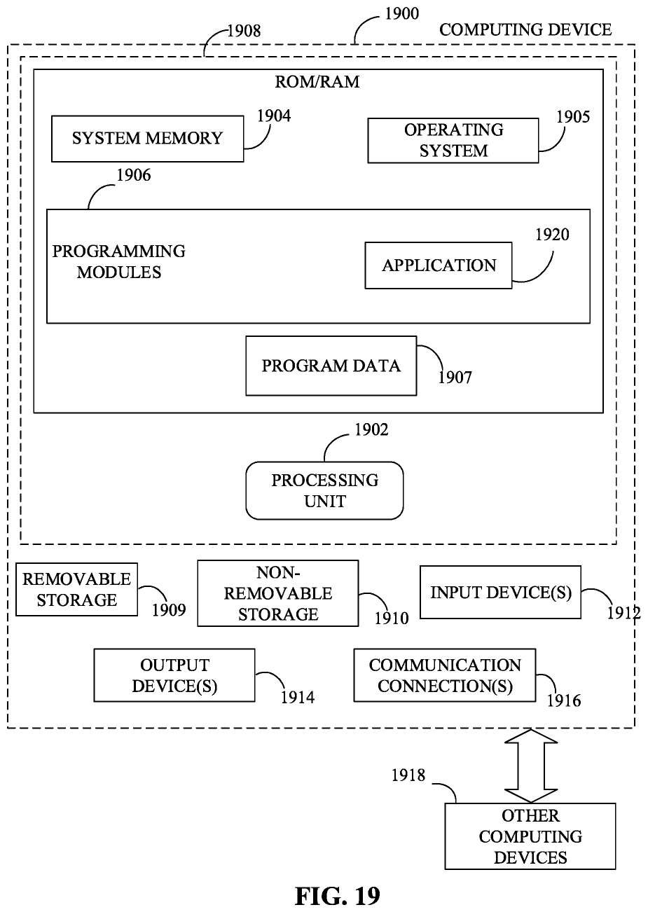

With reference to FIG. 19, a system consistent with an embodiment of the disclosure may include a computing device or cloud service, such as computing device 1900. In a basic configuration, computing device 1900 may include at least one processing unit 1902 and a system memory 1904. Depending on the configuration and type of computing device, system memory 1904 may comprise, but is not limited to, volatile (e.g. random-access memory (RAM)), non-volatile (e.g. read-only memory (ROM)), flash memory, or any combination. System memory 1904 may include operating system 1905, one or more programming modules 1906, and may include a program data 1907. Operating system 1905, for example, may be suitable for controlling computing device 1900's operation. In one embodiment, programming modules 1906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 19 by those components within a dashed line 1908.

Computing device 1900 may have additional features or functionality. For example, computing device 1900 may also include additional data storage devices (removable and/or non-removable) such as, for example, magnetic disks, optical disks, or tape. Such additional storage is illustrated in FIG. 19 by a removable storage 1909 and a non-removable storage 1910. Computer storage media may include volatile and non-volatile, removable and non-removable media implemented in any method or technology for storage of information, such as computer-readable instructions, data structures, program modules, or other data. System memory 1904, removable storage 1909, and non-removable storage 1910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1900. Any such computer storage media may be part of device 1900. Computing device 1900 may also have input device(s) 1912 such as a keyboard, a mouse, a pen, a sound input device, a touch input device, a location sensor, a camera, a biometric sensor, etc. Output device(s) 1914 such as a display, speakers, a printer, etc. may also be included. The aforementioned devices are examples and others may be used.

Computing device 1900 may also contain a communication connection 1916 that may allow device 1900 to communicate with other computing devices 1918, such as over a network in a distributed computing environment, for example, an intranet or the Internet. Communication connection 1916 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1904, including operating system 1905. While executing on processing unit 1902, programming modules 1906 (e.g., application 1920 such as a media player) may perform processes including, for example, one or more stages of methods, algorithms, systems, applications, servers, databases as described above. The aforementioned process is an example, and processing unit 1902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A system for facilitating performing of motion analysis in a field of interest, the system comprising:
at least one passive sensor disposed in the field of interest, wherein the field of interest comprises at least one object associated with at least one motion, wherein the at least one passive sensor is configured for generating passive sensor data based on receiving of first waves associated with the field of interest;
at least one active sensor disposed in the field of interest, wherein the at least one active sensor is configured for:
producing second waves, wherein the second waves are configured for reflecting of the at least one object based on the producing;
receiving transformed waves based on the reflecting; and
generating active sensor data based on the receiving of the transformed waves; and
at least one gateway disposable proximal to the field of interest, wherein the at least one gateway is configured as a two-way interface capable of communicating with a remote monitoring center, the at least one passive sensor and the at least one active sensor, wherein the at least one gateway is configured for transmitting the passive sensor data and the active sensor data to the remote monitoring center, wherein the remote monitoring center is configured for performing the motion analysis, wherein the remote monitoring center comprises a remote processing device, wherein the remote processing device is configured for:
combining the passive sensor data and the active sensor data; and
generating motion information based on the combining.

2. The system of claim 1, wherein at least one of the at least one active sensor and the at least one passive sensor is associated with at least one field of view, wherein the at least one field of view comprises at least one spatial region of the field of interest within which the at least one motion of the at least one object is detectable by the at least one of the at least one active sensor and the at least one passive sensor.

3. The system of claim 1 further comprising a local processing device communicatively coupled with the at least one active sensor, wherein the at least one gateway is communicatively coupled with the local processing device, wherein the local processing device is configured for:
preprocessing the active sensor data; and
extracting first active sensor data from the active sensor data based on the preprocessing, wherein the at least one gateway is configured for transmitting the first active sensor data to the remote monitoring center, wherein the remote processing device is configured for combining the first active sensor data and the passive sensor data, wherein the generating of the motion information is based on the combining of the first active sensor data and the passive sensor data.

4. The system of claim 1, wherein at least one of the at least one passive sensor and the at least one active sensor is disposed as at least one network in the field of interest.

5. The system of claim 1, wherein each of the at least one active sensor and the at least one passive sensor is associated with a resolution and a sensitivity, wherein the at least one active sensor comprises at least one active sensor resolution and at least one active sensor sensitivity, wherein the at least one passive sensor comprises at least one passive sensor resolution and at least one passive sensor sensitivity, wherein the at least one active sensor resolution is higher than the at least one passive sensor resolution, wherein the at least one active sensor sensitivity is lower than the at least one passive sensor sensitivity.

6. The system of claim 5, wherein the at least one active sensor resolution is lower than the at least one passive sensor resolution, wherein the at least one active sensor sensitivity is higher than the at least one passive sensor sensitivity.

7. The system of claim 5, wherein the passive sensor data corresponds to at least one of the resolution and the sensitivity of the at least one passive sensor, wherein the active sensor data corresponds to at least one of the resolution and the sensitivity of the at least one active sensor, wherein the combining of the passive sensor data and the active sensor data is based on at least one of the resolution and the sensitivity of each of the at least one active sensor and the at least one passive sensor.

8. The system of claim 1, wherein the at least one passive sensor comprises a plurality of passive motion sensors, wherein the plurality of passive motion sensors and at least one video camera are communicatively coupled with a local processing device, wherein the local processing device is communicatively coupled with the at least one gateway, wherein the plurality of passive motion sensors and the at least one video camera are disposed of in an indoor environment of the field of interest, wherein each video camera is configured to capture image sequences associated with a portion of the field of interest, wherein the local processing device is configured for preprocessing the image sequences, wherein the at least one gateway is configured for transmitting the image sequences to the remote monitoring center based on the preprocessing, wherein the remote processing device is configured for combining the image sequences and the passive sensor data based on the preprocessing, wherein the generating of the motion information is based on the combining of the image sequences and the passive sensor data.

9. The system of claim 1, wherein the at least one passive sensor comprises a plurality of passive motion sensors, wherein the plurality of passive motion sensors and the at least one active sensor are communicatively coupled with a local processing device, wherein the local processing device is communicatively coupled with the at least one gateway, wherein the plurality of passive motion sensors and the at least one active sensor are disposed of in an indoor environment of the field of interest, wherein each active sensor is configured to capture the active sensor data associated with a portion of the field of interest, wherein the local processing device is configured for preprocessing the active sensor data, wherein the at least one gateway is configured for transmitting the active sensor data to the remote monitoring center based on the preprocessing, wherein the remote processing device is configured for combining the active sensor data and the passive sensor data based on the preprocessing, wherein the generating of the motion information is based on the combining of the active sensor data and the passive sensor data.

10. The system of claim 1, wherein the at least one active sensor comprises a plurality of active motion sensors, wherein the plurality of active motion sensors and at least one video camera are communicatively coupled with a local processing device, wherein the local processing device is communicatively coupled with at least one gateway, wherein the plurality of active motion sensors and the at least one video camera are disposed of in an outdoor environment of the field of interest, wherein each video camera is configured to capture image sequences associated with a portion of the field of interest, wherein the local processing device is configured for preprocessing the image sequences and the active sensor data, wherein the at least one gateway is configured for transmitting the image sequences and the active sensor data to the remote monitoring center, wherein the remote processing device is configured for combining the image sequences and the active sensor data based on the preprocessing, wherein the generating of the motion information is based on the combining of the image sequences and the active sensor data.

11. The system of claim 1, wherein the at least one passive sensor comprises a plurality of passive motion sensors, wherein the plurality of passive motion sensors and the at least one active sensor are communicatively coupled with a local processing device, wherein the local processing device is communicatively coupled with the at least one gateway, wherein the plurality of passive sensors and the at least one active sensor are disposed of in an outdoor environment of the field of interest, wherein each active sensor is configured to capture the active sensor data associated with a portion of the field of interest, wherein the local processing device is configured for preprocessing the active sensor data, wherein the at least one gateway is configured for transmitting the active sensor data to the remote monitoring center, wherein the remote processing device is configured for combining the active sensor data and the passive sensor data based on the preprocessing, wherein the generating of the motion information is based on the combining of the active sensor data and the passive sensor data.

12. The system of claim 1, wherein the at least one active sensor is associated with at least one first field of view and the at least one passive sensor is associated with at least one second field of view, wherein the at least one first field of view and the at least one second field of view intersect to form at least one overlapping region, wherein the passive sensor data and the active sensor data is associated with the at least one overlapping region.

13. The system of claim 1, wherein each of the passive sensor data and the active sensor data comprises at least one type of at least one information of the at least one object, wherein the combining of the passive sensor data and active sensor data is based on the at least one type of the at least one information.

14. The system of claim 1, wherein at least one of the at least one active sensor and the at least one passive sensor is configured for mapping the field of interest, wherein the field of interest comprises a three-dimensional space, wherein the mapping comprises generating at least one three-dimensional representation of the three-dimensional space, wherein the at least one three-dimensional representation comprises a reflected intensity response associated with the three-dimensional space versus at least two orthogonal projections associated with the three-dimensional space, wherein the generating of the passive sensor data is based on the mapping, wherein the generating of the active sensor data is based on the mapping.

15. A system for facilitating performing of motion analysis in a field of interest, the system comprising:
at least one passive sensor disposed in the field of interest, wherein the field of interest comprises at least one object associated with at least one motion, wherein the at least one passive sensor is configured for generating passive sensor data based on receiving of first waves associated with the field of interest;
at least one active sensor disposed in the field of interest, wherein the at least one active sensor is configured for:
producing second waves, wherein the second waves are configured for reflecting of the at least one object based on the producing;
receiving transformed waves based on the reflecting; and
generating active sensor data based on the receiving of the transformed waves;
a local processing device communicatively coupled with the at least one passive sensor and the at least one active sensor, wherein the local processing device is configured for:
preprocessing the active sensor data; and
extracting first active sensor data from the active sensor data based on the preprocessing; and
at least one gateway disposable proximal to the field of interest, wherein the at least one gateway is configured as a two-way interface capable of communicating with a remote monitoring center and the local processing device, wherein the at least one gateway is configured for transmitting the first active sensor data and the passive sensor data to the remote monitoring center, wherein the remote monitoring center is configured for performing the motion analysis, wherein the remote monitoring center comprises a remote processing device, wherein the remote processing device is configured for:
combining the passive sensor data and the first active sensor data; and
generating motion information based on the combining.

16. The system of claim 15, wherein at least one of the at least one active sensor and the at least one passive sensor is associated with at least one field of view, wherein the at least one field of view comprises at least one spatial region of the field of interest within which the at least one motion of the at least one object is detectable by the at least one of the at least one active sensor and the at least one passive sensor.

17. The system of claim 15, wherein at least one of the at least one passive sensor and the at least one active sensor is disposed as at least one network in the field of interest.

18. The system of claim 15, wherein each of the at least one active sensor and the at least one passive sensor is associated with a resolution and a sensitivity, wherein the at least one active sensor comprises at least one active sensor resolution and at least one active sensor sensitivity, wherein the at least one passive sensor comprises at least one passive sensor resolution and at least one passive sensor sensitivity, wherein the at least one active sensor resolution is higher than the at least one passive sensor resolution, wherein the at least one active sensor sensitivity is lower than the at least one passive sensor sensitivity.

19. The system of claim 18, wherein the at least one active sensor resolution is lower than the at least one passive sensor resolution, wherein the at least one active sensor sensitivity is higher than the at least one passive sensor sensitivity.

20. The system of claim 18, wherein the passive sensor data corresponds to at least one of the resolution and the sensitivity of the at least one passive sensor, wherein the active sensor data corresponds to at least one of the resolution and the sensitivity of the at least one active sensor, wherein the combining of the passive sensor data and the first active sensor data is based on at least one of the resolution and the sensitivity of each of the at least one active sensor and the at least one passive sensor.
